(19) United States
(12) Patent Application Publication
(10) Pub. No.: US 2018/0089960 A1
(43) Pub. Date: Mar. 29, 2018

(54) Hybrid Electronic Gaming Machine with Persistent Skill Enhancements

(71) Applicant: IGT, Las Vegas, NV (US)

(72) Inventors: Scott Caputo, Santa Clara, CA (US); Cameron Filipour, Las Vegas, NV (US); Bryan S. B. Upton, Hertfordshire (GB)

(21) Appl. No.: 15/274,965

(22) Filed: Sep. 23, 2016

(51) Int. Cl. G07F 17/32

(52) U.S. Cl. CPC G07F 17/3295; G07F 17/3209; G07F 17/3211; G07F 17/3246; G07F 17/3239; G07F 17/329; G07F 17/3258; G07F 17/3262; G07F 17/3251

(57) ABSTRACT

A gaming system offers players the opportunity to play a skill-based challenge. Following the skill-based challenge, the player plays a chance-based prize round in which the player has the opportunity to win a prize. The gaming system receives a wager from a player and determines that the player has purchased a persistent skill enhancement that can be used by the player whenever the player is playing the skill-based challenge. The gaming system initiates the skill-based challenge including the persistent skill enhancement. Upon completion of the skill-based challenge, the gaming system awards the player at least one entry into a chance-based prize round. The probability of winning the chance-based prize round may be enhanced based on the outcome of the skill-based challenge. The gaming system then initiates the chance-based prize round and may award a monetary prize to the player in response to an outcome of the chance-based prize round.

### COPYRIGHT NOTICE

A portion of the disclosure of this patent document contains or may contain material that is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Electronic and electro-mechanical gaming machines (EGMs) are systems that allow users to place a wager on the outcome of a random event, such as the spinning of mechanical or virtual reels or wheels, the playing of virtual cards, the rolling of mechanical or virtual dice, the random placement of tiles on a screen, etc. The outcomes of such events are purely random or pseudo-random, and indeed, the requirement for randomness or pseudo-randomness of the outcomes is regulated in many jurisdictions.

Gambling on these systems may be contrasted with some other types of gambling, such as blackjack and poker, in which a player may increase their chance of winning a wager by playing the game with some level of skill relative to other players. Even in those games, however, a player cannot readily overcome the inherent randomness and odds of the game regardless of the player's skill.

Games of pure or primarily skill have not previously been successfully used in casinos because the skill element overrides other factors in determining an outcome. Further, it makes the game only popular amongst those that are skilled and not others. Moreover, until recently, many jurisdictions prevented the incorporation of skill based rewards in EGMs.

Games of skill, however, can be highly attractive to players who enjoy the possibility of using their skills and wits to overcome odds against them. Moreover, the new generations of customers are familiar with skill-based games. Accordingly, a number of jurisdictions have recently begun to permit manufacturers to incorporate skill-based aspects into games hosted on EGMs.

In response, EGM manufacturers have started to incorporate some elements of skill along with chance into their games. Games in which a combination of chance and a player's skill govern the ultimate outcome are referred to herein as “hybrid” games.

Incorporating skill into an EGM involves a number of challenges, however. For example, to ensure that EGMs perform within specified payback percentages and meet regulatory requirements, it is important that a skill-based game offered by an EGM maintains some form of random determination. Controlling the payback percentage is more difficult when skill is allowed to affect the outcome. Moreover, players who perceive themselves as lacking skill may be discouraged from playing a game that involves skill.

Accordingly, EGM manufacturers are actively seeking ways to incorporate skill-based gaming or skill based aspects into their EGMs in a way that meets financial and regulatory requirements, but also in a way that makes the games more attractive and exciting to players.

### SUMMARY

Some embodiments of the inventive concepts provide a wagering gaming system that offers players the opportunity to play a skill-based challenge followed by a chance-based prize round in which the player has the opportunity to win a prize. When the skill-based challenge is played, the player may use a persistent skill enhancement to improve the player's performance of the skill-based challenge. The persistent skill enhancement can be used any time the player plays the skill-based challenge on the gaming system.

The gaming system initiates the skill-based challenge including the persistent skill enhancement. Upon completion of the skill-based challenge, the gaming system awards the player at least one entry into a chance-based prize round. The probability of winning the chance-based prize round may be enhanced based on the outcome of the skill-based challenge. The gaming system then initiates the chance-based prize round and may award a monetary prize to the player in response to an outcome of the chance-based prize round.

The persistent skill enhancement may be indicated or provided in a number of ways, such as a tool, object, key, icon, character, or avatar that provides enhanced abilities or powers to the player during gameplay. The persistent skill enhancement may be implemented in the form of increased speed, agility or ability of an icon or screen character that is used to perform the skill-based challenge.

The persistent skill enhancement may be usable by the player in the skill-based challenge and in subsequent plays of the skill-based challenge. Furthermore, the persistent skill enhancement may be usable by the player in subsequent plays of the skill-based challenge on different gaming systems, which may be located on the same or different premises. In some embodiments, the persistent skill enhancement may be usable by the player in subsequent plays of the skill-based challenge on different gaming systems operated by different casino operators.

### BRIEF DESCRIPTION OF THE DRAWINGS

FIG. 1A is a perspective view of an electronic gaming device that can be configured according to some embodiments.

FIG. 1B is a schematic block diagram illustrating an electronic configuration for a gaming device according to some embodiments.

FIG. 1C is a block diagram that illustrates various functional modules of an electronic gaming device according to some embodiments.

FIG. 1D is perspective view of a handheld electronic gaming device that can be configured according to some embodiments.

FIG. 1E is a perspective view of an electronic gaming device according to further embodiments.

FIG. 2 is a schematic block diagram illustrating a network configuration for a plurality of gaming devices according to some embodiments.

FIGS. 3 to 5 are process flow diagrams illustrating operations of systems/methods according to various embodiments.

FIGS. 6A and 6B illustrate images that can be displayed on a display device according to some embodiments.

FIGS. 7A to 7C illustrate screen configurations that can be displayed on a display device according to some embodiments.

FIGS. 8A to 8D illustrate images that can be displayed on a display device during gameplay of a skill-based challenge according to some embodiments.

FIGS. 9A to 9F illustrate images that can be displayed on a display device during gameplay of a chance-based prize round according to some embodiments.

FIG. 10 is a block diagram illustrating a network configuration of a wide area progressive jackpot game according to some embodiments.

### DETAILED DESCRIPTION

Embodiments of the inventive concepts provide hybrid skill- and chance-based electronic wagering games that provide an opportunity for players to obtain and use persistent skill enhancements. As noted above, the electronic gaming industry is moving towards adoption of skill-based gaming. While this has the possibility of attracting new players and increasing their enjoyment of electronic wagering games, the addition of skill based aspects to electronic gaming also has the possibility of discouraging players who perceive themselves as lacking skill in the use of the game mechanic employed in the skill-based aspect of the game. Providing the ability to purchase or otherwise obtain a persistent skill enhancement may encourage certain players to play, thereby increasing overall player adoption and loyalty to the game, and, ultimately, increasing the total amount wagered by players on the game.

Electronic Gaming Machines

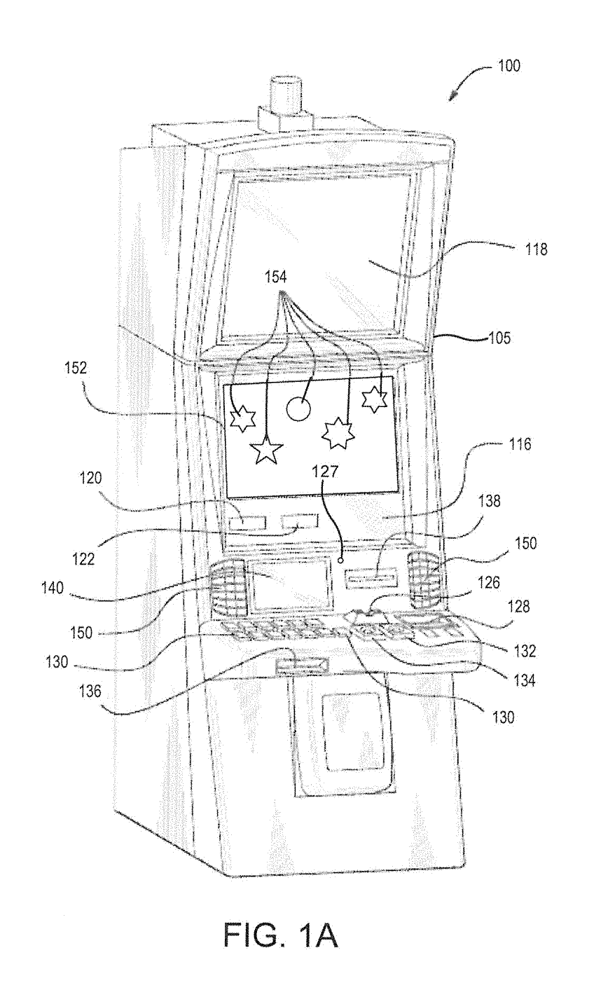

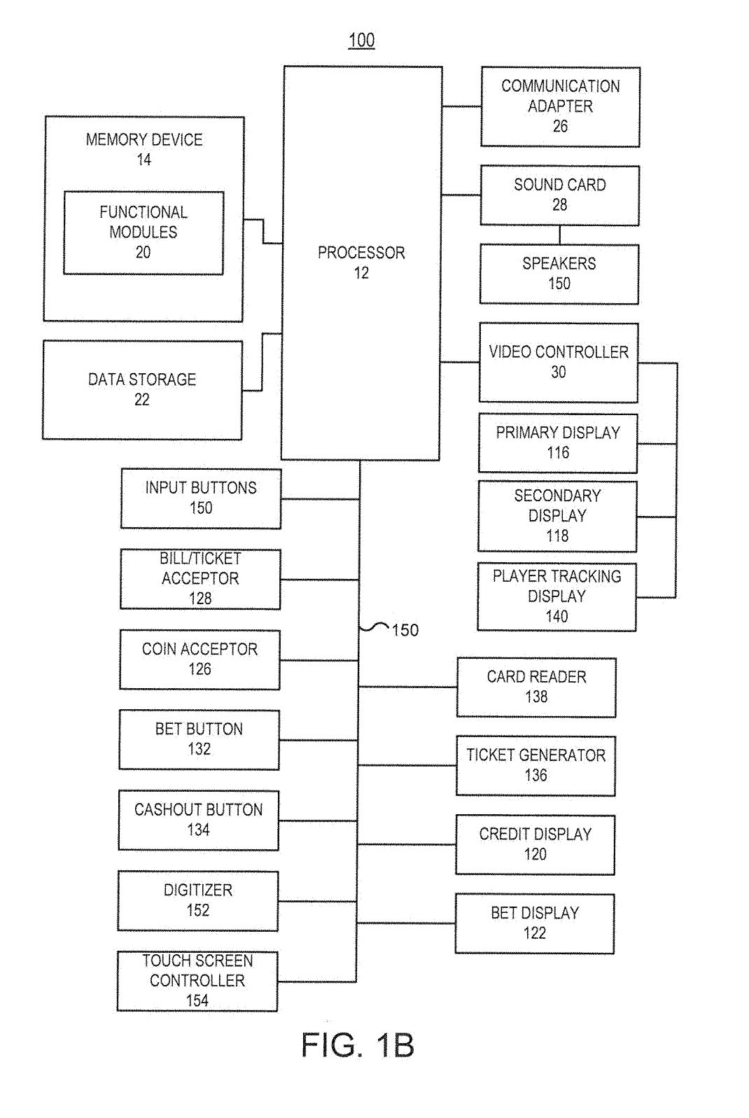

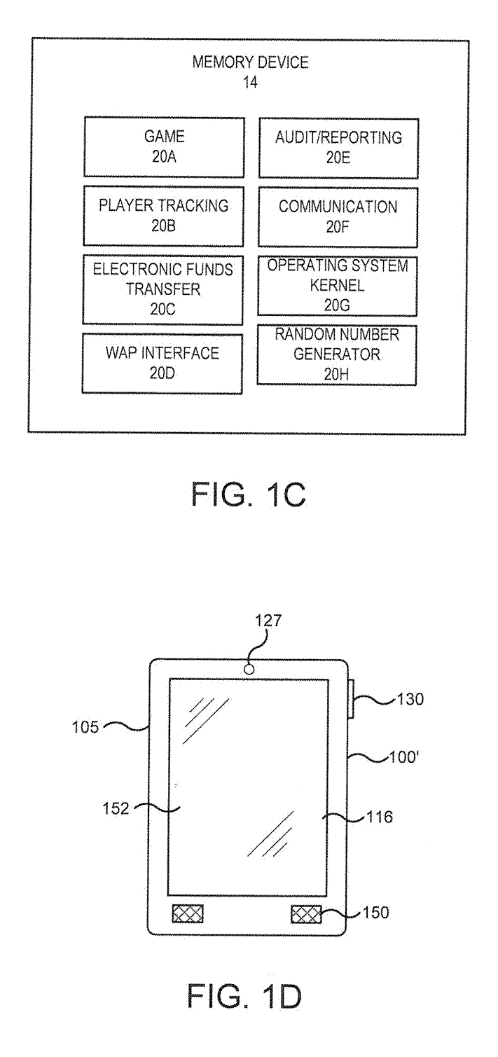

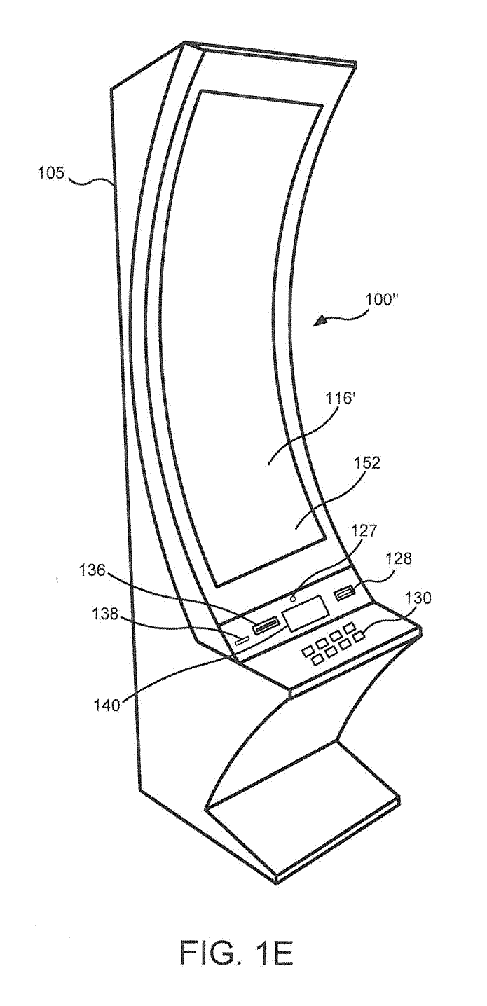

An example of an electronic gaming machine (EGM) that can host hybrid games according to various embodiments is illustrated in FIGS. 1A, 1B, and 1C in which FIG. 1A is a perspective view of an EGM 100 illustrating various physical features of the device, FIG. 1B is a functional block diagram that schematically illustrates an electronic relationship of various elements of the EGM 100, and FIG. 1C illustrates various functional modules that can be stored in a memory device of the EGM 100. The embodiments shown in FIGS. 1A to 1C are provided as examples for illustrative purposes only. It will be appreciated that EGMs may come in many different shapes, sizes, layouts, form factors, and configurations, and with varying numbers and types of input and output devices, and that embodiments of the inventive concepts are not limited to the particular EGM structures described herein.

EGMs typically include a number of standard features, many of which are illustrated in FIGS. 1A and 1B. For example, referring to FIG. 1A, an EGM 100 may include a support structure, housing or cabinet 105 which provides support for a plurality of displays, inputs, outputs, controls and other features that enable a player to interact with the EGM 100.

The EGM 100 illustrated in FIG. 1A includes a number of display devices, including a primary display device 116 located in a central portion of the cabinet 105 and a secondary display device 118 located in an upper portion of the cabinet 105. It will be appreciated that one or more of the display devices 116, 118 may be omitted, or that the display devices 116, 118 may be combined into a single display device. The EGM 100 may further include a player tracking display 140, a credit display 120, and a bet display 122. The credit display 120 displays a player's current number of credits, cash, account balance or the equivalent. The bet display 122 displays a player's amount wagered.

The player tracking display 140 may be used to display a service window that allows the player to interact with, for example, their player loyalty account to obtain features, bonuses, comps, etc. In other embodiments, additional display screens may be provided beyond those illustrated in FIG. 1A.

The EGM 100 may further include a number of input devices that allow a player to provide various inputs to the EGM 100, either before, during or after a game has been played. For example, the EGM 100 may include a plurality of input buttons 130 that allow the player to select options before, during or after game play. The EGM may further include a game play initiation button 132 and a cashout button 134. The cashout button 134 is utilized to receive a cash payment or any other suitable form of payment corresponding to a quantity of remaining credits of a credit display.

In some embodiments, one or more input devices of the EGM 100 are one or more game play activation devices that are each used to initiate a play of a game on the EGM 100 or a sequence of events associated with the EGM 100 following appropriate funding of the EGM 100. The example EGM 100 illustrated in FIGS. 1A and 1B includes a game play activation device in the form of a game play initiation button 132. It should be appreciated that, in other embodiments, the EGM 100 begins game play automatically upon appropriate funding rather than upon utilization of the game play activation device.

In some embodiments, one or more input devices of the EGM 100 are one or more wagering or betting devices. One such wagering or betting device is as a maximum wagering or betting device that, when utilized, causes a maximum wager to be placed. Another such wagering or betting device is a repeat the bet device that, when utilized, causes the previously-placed wager to be placed. A further such wagering or betting device is a bet one device. A bet is placed upon utilization of the bet one device. The bet is increased by one credit each time the bet one device is utilized. Upon the utilization of the bet one device, a quantity of credits shown in a credit display (as described below) decreases by one, and a number of credits shown in a bet display (as described below) increases by one.

In some embodiments, one or more of the display screens may a touch-sensitive display that includes a digitizer 152 and a touchscreen controller 154 (FIG. 1B). The player may interact with the EGM 100 by touching virtual buttons on one or more of the display devices 116, 118, 140. Accordingly, any of the above described input devices, such as the input buttons 130, the game play initiation button 132 and/or the cashout button 134 may be provided as virtual buttons on one or more of the display devices 116, 118, 140.

Referring briefly to FIG. 1B, operation of the primary display device 116, the secondary display device 118 and the player tracking display 140 may be controlled by a video controller 30 that receives video data from a processor 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor 12. In some embodiments however, the credit display 120 and/or the bet display 122 may be driven by the video controller 30.

Referring again to FIG. 1A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device 116, 118. 140 may includes a touch-screen with an associated touch-screen controller 154 and digitizer 152. The display devices 116, 118. 140 may be of any suitable size, shape, and/or configuration. The display devices 116, 118. 140 may include flat or curved display surfaces.

The display devices 116, 118, 140 and video controller 30 of the EGM 100 are generally configured to display one or more game and/or non-game images, symbols, and indicia. In certain embodiments, the display devices 116, 118. 140 of the EGM 100 are configured to display any suitable visual representation or exhibition of the movement of objects; dynamic lighting; video images; images of people, characters, places, things, and faces of cards; and the like. In certain embodiments, the display devices 116, 118. 140 of the EGM 100 are configured to display one or more virtual reels, one or more virtual wheels, and/or one or more virtual dice. In other embodiments, certain of the displayed images, symbols, and indicia are in mechanical form. That is, in these embodiments, the display device 116, 118. 140 includes any electromechanical device, such as one or more rotatable wheels, one or more reels, and/or one or more dice, configured to display at least one or a plurality of game or other suitable images, symbols, or indicia.

The EGM 100 also includes various features that enable a player to deposit credits in the EGM 100 and withdraw credits from the EGM 100, such as in the form of a payout of winnings, credits, etc. For example, the EGM 100 may include a ticket dispenser 136 that is configured to generate and provide a ticket or credit slip representing a payout and/or a credit balance. The ticket or credit slip is printed by the EGM 100 when the cashout button 134 is pressed, and typically includes a barcode or similar device that allows the ticket to be redeemed via a cashier, a kiosk, or other suitable redemption system, or to be deposited into another gaming machine. The EGM 100 may further include a bill/ticket acceptor 128 that allows a player to deposit credits in the EGM 100 in the form of paper money or a ticket/credit slip, and a coin acceptor 126 that allows the player to deposit coins into the EGM 100.

While not illustrated in FIG. 1A, the EGM 100 may also include a note dispenser configured to dispense paper currency and/or a coin generator configured to dispense coins or tokens in a coin payout tray.

The EGM 100 may further include one or more speakers 150 controlled by one or more sound cards 28 (FIG. 1B). The EGM 100 illustrated in FIG. 1A includes a pair of speakers 150. In other embodiments, additional speakers, such as surround sound speakers, may be provided within or on the cabinet 105. Moreover, the EGM 100 may include built-in seating with integrated headrest speakers.

In various embodiments, the EGM 100 may generate dynamic sounds coupled with attractive multimedia images displayed on one or more of the display devices 116, 118. 140 to provide an audio-visual representation or to otherwise display full-motion video with sound to attract players to the EGM 100 and/or to engage the player during gameplay. In certain embodiments, the EGM 100 may display a sequence of audio and/or visual attraction messages during idle periods to attract potential players to the EGM 100. The videos may be customized to provide any appropriate information.

The EGM 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor determines the amount of funds entered and displays the corresponding amount on the credit or other suitable display as described above.

In some embodiments, the EGM 100 may include an electronic payout device or module configured to fund an electronically recordable identification card or smart card or a bank or other account via an electronic funds transfer to or from the EGM 100.

FIG. 1B is a block diagram that illustrates logical and functional relationships between various components of an EGM 100. As shown in FIG. 1B, the EGM 100 may include a processor 12 that controls operations of the EGM 100. Although illustrated as a single processor, multiple special purpose and/or general purpose processors and/or processor cores may be provided in the EGM 100. For example, the EGM 100 may include one or more of a video processor, a signal processor, a sound processor and/or a communication controller that performs one or more control functions within the EGM 100. The processor 12 may be variously referred to as a “controller,” “microcontroller,” “microprocessor” or simply a “computer.” The processor may further include one or more application-specific integrated circuits (ASICs).

Various components of the EGM 100 are illustrated in FIG. 1B as being connected to the processor 12. It will be appreciated that the components may be connected to the processor 12 through a system bus, a communication bus and controller, such as a USB controller and USB bus, a network interface, or any other suitable type of connection.

The EGM 100 further includes a memory device 14 that stores one or more functional modules 20. Various functional modules 20 of the EGM 100 will be described in more detail below in connection with FIG. 1D.

The memory device 14 may store program code and instructions, executable by the processor 12, to control the EGM 100. The memory device 14 may also store other data such as image data, event data, player input data, random or pseudo-random number generators, paytable data or information and applicable game rules that relate to the play of the gaming device. The memory device 14 may include random access memory (RAM), which can include non-volatile RAM (NVRAM), magnetic RAM (MRAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The EGM 100 may further include a data storage device 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The EGM 100 may include a communication adapter 26 that enables the EGM 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the EGM 100 to communicate, for example, with a mobile communication device operated by a player.

The EGM 100 may include one or more internal or external communication ports that enable the processor 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor through a universal serial bus (USB) hub (not shown) connected to the processor 12. U.S. Patent Application Publication No. 2004/0254014 describes a variety of EGMs including one or more communication ports that enable the EGMs to communicate and operate with one or more external peripherals.

In some embodiments, the EGM 100 may include a sensor, such as a camera in communication with the processor 12 (and possibly controlled by the processor 12) that is selectively positioned to acquire an image of a player actively using the EGM 100 and/or the surrounding area of the EGM 100. In one embodiment, the camera may be configured to selectively acquire still or moving (e.g., video) images and may be configured to acquire the images in either an analog, digital or other suitable format. The display devices 116, 118, 140 may be configured to display the image acquired by the camera as well as display the visible manifestation of the game in split screen or picture-in-picture fashion. For example, the camera may acquire an image of the player and the processor 12 may incorporate that image into the primary and/or secondary game as a game image, symbol or indicia.

Various functional modules of that may be stored in a memory device 14 of an EGM 100 are illustrated in FIG. 1C. Referring to FIG. 1C, the EGM 100 may include in the memory device 14 a game module 20A that includes program instructions and/or data for operating a hybrid wagering game as described herein. The EGM 100 may further include a player tracking module 20B, an electronic funds transfer module 20C, a wide area progressive module 20D, an audit/reporting module 20E, a communication module 20F, an operating system 20G and a random number generator 20H. The player tracking module 20B keeps track of the play of a player. The electronic funds transfer module 20C communicates with a back end server or financial institution to transfer funds to and from an account associated with the player. The wide area progressive (WAP) interface module 20D interacts with a remote WAP server to enable the EGM 100 to participate in a wide area progressive jackpot game as described in more detail below. The communication module 20F enables the EGM 100 to communicate with remote servers and other EGMs using various secure communication interfaces. The operating system kernel 20G controls the overall operation of the EGM 100, including the loading and operation of other modules. The random number generator 20H generates random or pseudorandom numbers for use in the operation of the hybrid games described herein.

In some embodiments, an EGM 100 may be implemented by a desktop computer, a laptop personal computer, a personal digital assistant (PDA), portable computing device, or other computerized platform. In some embodiments, the EGM 100 may be operable over a wireless network, such as part of a wireless gaming system. In such embodiments, the gaming machine may be a hand held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 1D, an EGM 100′ may be implemented as a handheld device including a compact housing 105 on which is mounted a touchscreen display device 116 including a digitizer 152. An input button 130 may be provided on the housing and may act as a power or control button. A camera 127 may be provided in a front face of the housing 105. The housing 105 may include one or more speakers 150. In the EGM 100′, various input buttons described above, such as the cashout button, gameplay activation button, etc., may be implemented as soft buttons on the touchscreen display device 116. Moreover, the EGM 100′ may omit certain features, such as a bill acceptor, a ticket generator, a coin acceptor or dispenser, a card reader, secondary displays, a bet display, a credit display, etc. Credits can be deposited in or transferred from the EGM 100′ electronically.

FIG. 1E illustrates a standalone EGM 100″ having a different form factor from the EGM 100 illustrated in FIG. 1A. In particular, the EGM 100″ is characterized by having a large, high aspect ratio, curved primary display device 116′ provided in the housing 105, with no secondary display device. The primary display device 116′ may include a digitizer 152 to allow touchscreen interaction with the primary display device 116′. The EGM 100″ may further include a player tracking display 140, a plurality of input buttons 130, a bill/ticket acceptor 128, a card reader 138, and a ticket generator 136. The EGM 100″ may further include one or more cameras 127 to enable facial recognition and/or motion tracking.

EGM Network

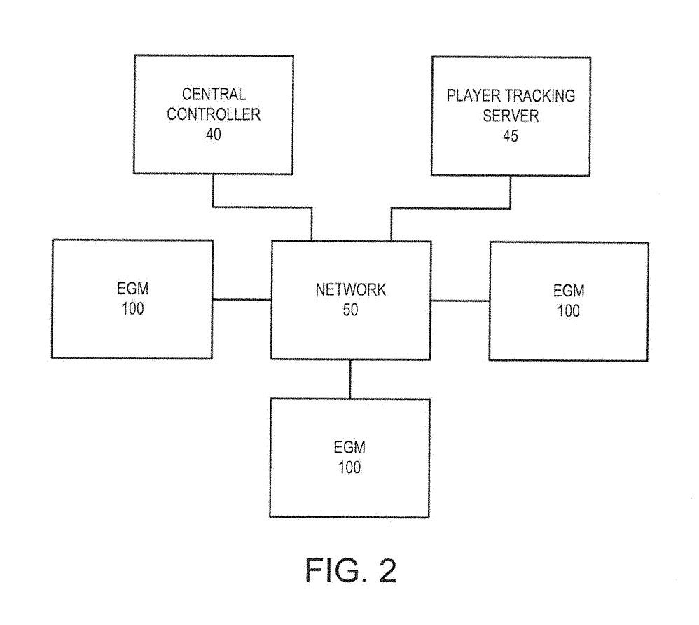

Referring to FIG. 2, one or more EGMs 100 may be in communication with each other and/or at least one central controller 40 through a data network or remote communication link 50. The data network 50 may be a private data communication network that is operated, for example, by the gaming facility that operates the EGM 100. Communications over the data network 50 may be encrypted for security. The central controller 40 may be any suitable server or computing device which includes at least one processor and at least one memory or storage device. In different such embodiments, the central controller 40 is a progressive controller or a processor of one of the gaming devices in the gaming system. In these embodiments, the processor of each gaming device is designed to transmit and receive events, messages, commands or any other suitable data or signal between the individual gaming device and the central server. The gaming device processor is operable to execute such communicated events, messages or commands in conjunction with the operation of the gaming device. Moreover, the processor of the central controller 40 is designed to transmit and receive events, messages, commands or any other suitable data or signal between the central controller 40 and each of the individual EGMs 100. The central controller 40 is operable to execute such communicated events, messages or commands in conjunction with the operation of the central server. It should be appreciated that one, more or each of the functions of the central controller 40 as disclosed herein may be performed by one or more EGM processors. It should be further appreciated that one, more or each of the functions of one or more EGM processors as disclosed herein may be performed by the central controller 40.

A player tracking server 45 may also be connected through the data network 50. The player tracking server 45 may manage a player tracking account that tracks the player's gameplay and spending, manages loyalty awards for the player, manages funds deposited or advanced on behalf of the player, and other functions. In some embodiments of the inventive concepts, the player tracking server 45 also keeps track of persistent skill enhancements that have been purchased or otherwise obtained by the player in connection with particular games.

Operation of Hybrid Game

Embodiments of the inventive concepts provide a hybrid game that involves a skill-based challenge followed by a chance-based wagering game. When a player initiates gameplay, a skill-based challenge is first presented to the player by the EGM 100. The player must complete the skill based challenge, and upon completion of the skill-based challenge or game, the player's performance in the skill-based challenge or game is rated. For example, the player's performance may be rated on the basis of zero to four stars, where zero stars are awarded for poor performance and four stars are awarded for superior performance. Many other kinds of rating systems may be used, such as ranking the player's performance on a scale of 1 to 10, ranking the player's performance on a scale of gold, silver and bronze, or by any other desired scale.

Once the player has completed the skill-based challenge, and the player's performance has been rated, the player may be allowed to participate in chance-based prize round in which player has an opportunity to win a prize or award, such as an award of credits, money, loyalty points, or any other item of value to the player. The probability of winning an award in the chance-based prize round may be defined by a paytable, which sets out the awards that can be won in response to the occurrence of various outcomes of the chance-based prize round, each of which has a predefined probability of occurrence.

The player's performance in the skill-based challenge or game may affect the outcome of the chance-based prize round in a number of ways. For example, the player may be awarded a number of entries, lives, or tries in the chance-based prize round based on the rating assigned to the player's performance of the skill-based challenge or game. In some embodiments, the paytable used to determine an award in the chance-based prize round may be changed based on the rating assigned to the player's performance of the skill-based challenge or game, such that the return-to-player (RTP) of the chance-based prize round may be increased or decreased based on the rating assigned to the player's performance of the skill-based challenge or game. RTP refers to the percentage of all the wagered money an EGM will pay back to players over a long time and/or a large quantity of wagers.

Accordingly, in some embodiments, the EGM 100 may evaluate a skill level of the player during play of the skill-based challenge, and select a paytable from among a plurality of potential paytables in response to the evaluated skill level of the player. The chance-based prize round may use the selected paytable so that the monetary prize, if any, that is awarded after the chance-based prize round is generated based on the selected paytable.

In some embodiments, the paytable used to determine an award in the chance-based prize round may be changed based on the rating assigned to the player's performance of the skill-based challenge or game, such that the volatility of the chance-based prize round may be increased or decreased based on the rating assigned to the player's performance of the skill-based challenge or game. In this context, volatility refers to the variation in the range of possible payouts of the chance-based prize round. For example, a game with low volatility may offer the possibility of winning only a small award, but with a high probability of winning an award on a given trial, while a game with high volatility may offer the possibility of winning a large award, but with only a small probability of winning the award on a given trial. Volatility is often inversely related to “hit frequency,” which may be expressed as a percentage of trials that result in a winning outcome.

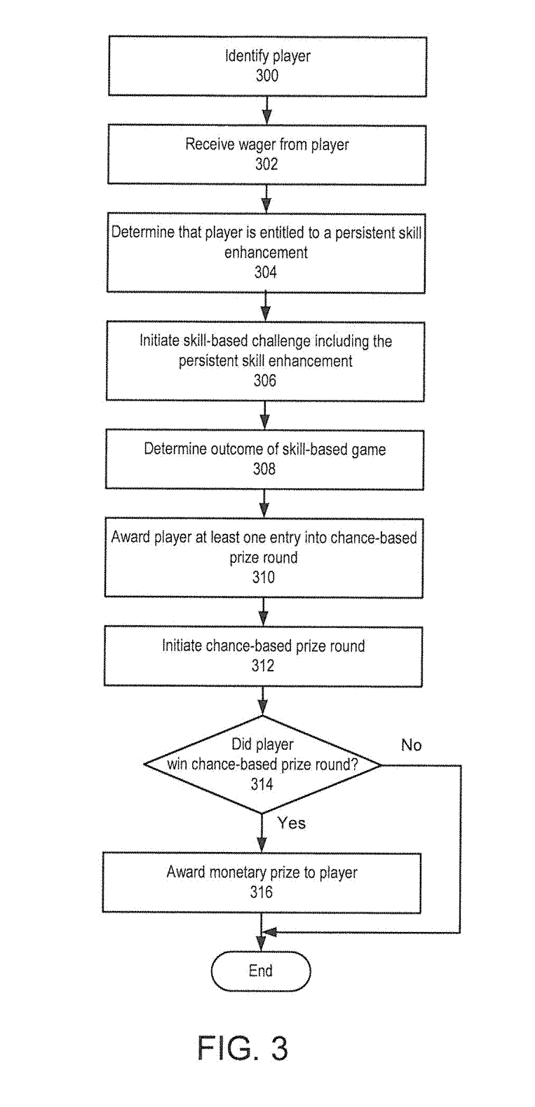

Operations of systems/methods according to some embodiments of the inventive concepts are illustrated in FIG. 3. Referring to FIG. 3, when a player logs in to the EGM 100 by, for example, inserting a loyalty card into the card reader 138, entering a username, etc., the EGM 100 may communicate with the central controller 40 or the player tracking system 45 to identify the player. In some embodiments, a camera 127 integrated into the EGM 100 may be used to obtain an image of the player, and the player may be identified using well-known face recognition techniques. Other methods that can be used to identify a player include wireless identification, such as identifying a mobile phone associated with the player using Bluetooth, WiFi, RFID and/or NFC wireless communications. The player may also be identified by logging into the EGM 100 with a username and password. Multiple methods of identification may be used in combination to verify a player's identity.

Player tracking, such as by using a player loyalty card and/or player loyalty account, may be used to identify the player so that the player's progress in the game can be saved. However, it will be appreciated that a player's progress or status can be saved in other ways besides using a player tracking system. For example, a player's status can be saved in an anonymous account. When the player cashes out of the EGM 100, the ticket generator 136 in the EGM 100 may print a ticket including a printed code, such as a bar code or QR code, that corresponds to the anonymous account. When the player wants to continue the game, the player may insert the ticket including the printed code into the bill/ticket acceptor 128 of an EGM 100 (which may or may not be the same EGM 100 from which the ticket was issued). The EGM 100 reads the printed code and retrieves the player's status from the anonymous account associated with the printed code.

Once the player has been identified, the EGM 100 may receive a player profile associated with the player from the central controller 40 or player tracking system 45 that contains information about the status of the player, and in particular may contain information about the player's history in playing the hybrid game. For example, the player's profile may indicate a current level of the player on the game, a current score of the player, a high score of the player, a number of credits available to the player, or any other information relevant to the player's play of the hybrid game. In particular, the EGM may determine from the player profile if the player is entitled to any gameplay enhancements, such as a persistent skill enhancement that applies in a skill-based portion of the game (block 302).

A game may commence when the EGM 100 receives a wager from a player (block 304). The player may place a wager by, for example, selecting a number of credits to bet and pressing the game play initiation button 132.

In particular, the EGM 100 may determine that the player has purchased at least one persistent skill enhancement to a skill-based challenge that can be used by the player whenever the player is playing the skill-based challenge. As used herein, “persistent” means that the player has the skill enhancement permanently in the game, or, in the case of a temporary enhancement, the skill enhancement will remain on the player's account indefinitely until used up or otherwise consumed in game. In some embodiments, the persistent skill enhancement may only be available to players of the skill-based challenge who have purchased or otherwise been awarded the persistent skill enhancement. The persistent skill enhancement may be purchased by the player using the EGM 100, either before or during game play. For example, the persistent skill enhancement may be purchased by the player before or during play of the skill-based challenge. The option to purchase the persistent skill enhancement may be displayed to the player on the primary display device 116, the secondary display device 118, or any other display device in the EGM 100. The option to purchase the persistent skill enhancement may in some embodiments be delivered to a mobile device associated with the player, such as via text message or email. In some embodiments, the option to purchase the persistent skill enhancement may be communicated to the player's mobile device via a short range communication link, such as a Bluetooth or near field communication (NFC) link between the EGM 100 and the player's mobile device.

The persistent skill enhancement may be purchased by the player through an online portal accessible from a web browser, at a kiosk, via mobile device, or elsewhere. In some embodiments, the persistent skill enhancement may be purchased through a player reward website, or a game-related website, such a website operated by a game developer, a casino operator, a game machine owner, etc. In some embodiments, the persistent skill enhancement may be purchased for credits, cash or loyalty points awarded by the gaming operator or an affiliated group of operators. In some embodiments a player can also purchase a temporary skill enhancement that lasts for a finite or individual game rounds only.

In some embodiments, the persistent skill advantage may be awarded to the player, for example, by a game operator, as a loyalty award based on one or more of (i) an amount of time played on the EGM 100; (ii) a bonus level of the player; (iii) an amount of money wagered on the EGM 100; (iv) an amount of money lost at the EGM 100; (v) an amount of money won at the EGM 100; (vi) an amount of money wagered at games in a gaming system; (vii) an amount of money lost at the EGMs in a gaming system; (viii) an amount of money won at the EGM 100 in a gaming system; (ix) an event or outcome occurring in a primary game of one of the EGMs 100; (x) an event occurring due to a shared random outcome generation; (xi) meeting one or more thresholds, such as a number of plays or a wager pool exceeding a designated amount; (xii) a random determination based on an amount wagered; (xiii) an occurrence of a predetermined event; (xiv) one or more side wagers placed; (xv) participation in multiplayer, community, player vs. player or team play game event involving other players, competing against each other or cooperating against the house; and (xvi) any combination of these.

In some embodiments, a scale may be used for determining the fee for buying a persistent skill enhancement. For example, in some embodiments, the scale may be defined such that it costs $X to purchase a low level skill enhancement, $2X to purchase a medium skill enhancement, or $4X to purchase a large skill enhancement. In some embodiments, the actual magnitude of enhancement that is provided to the player may be randomly determined. It should be appreciated that a sliding scale could be used to determine the fees associated with any suitable persistent skill enhancement.

In some embodiments, a game operator may set the fee for purchasing the persistent skill enhancement based on the average expected payout of the chance-based game. In alternative embodiments, rather than being determined based on average expected payout of the chance-based game, the fee may be determined based on other factors, such as a number of plays played by the player, a number of previous wins, a number of previous losses, or any combination of these. In other embodiments, the fee may be determined based on a sliding scale.

In some embodiments, the amount of the fee that the player has to pay for the persistent skill enhancement may vary based on when the player chooses to purchase the advantage. For example, a player who purchases the advantage while playing the game may be charged a higher fee than if that player had purchased the persistent skill enhancement before initiating game play, such as by purchasing the persistent skill enhancement through the player's loyalty account, online, or otherwise. In some embodiments, the fee may be based on the player's progress through the game, the skill level of the player, and/or the specific level or game round about to be played by the player.

In some embodiments, persistent skill enhancements can be purchased in bundles from a game or casino operator. When it is offered to the player, the bundle may identify which game the bundle is targeting, the total number of individual enhancements within the bundle, which enhancements are offered in the bundle, the number of each enhancement within the bundle, the price of the bundle, other items included in the bundle (e.g., downloadable content, coupons with the bundle purchase). Once created, a bundle can be saved as a template. Existing bundles can be copied to create a new bundle based on the settings of a previously created bundles.

The specific content of a bundle that is offered to the player may be based on the player's performance and/or behavior in a game. For example, a player's style of play may be analyzed to determine what kinds of features the player uses most often, and the bundle may include enhancements designed to complement those features.

Collections of persistent skill enhancements may be defined according to some embodiments. For example, collections may offer the player multiple versions of the same offer with different price points and volumes. For example, a given collection may offer 3 bundles: Bundle A offers 3 Super Enhancements for price $X; Bundle B offers 6 Super Enhancements for price $X+$X/2; and Bundle C offer 12 Super Enhancements for price $2X. Once created, a collection can be saved as a template. Existing collections can be copied to create a new collection based on the settings of a previously created collections.

Persistent skill enhancements may be categorized as pregame skill enhancements, dynamic skill enhancements, mystery skill enhancements and wager performance enhancements. Each of these categories is described below.

Pregame Skill Enhancements

Pregame skill enhancements offer the player the opportunity to increase his or her chances at success in a game by making a larger base wager. In some embodiments, before a game is initiated, the player is offered pregame skill enhancements as a wagering option. Typically, each pregame skill enhancement will convey some special advantage to the player in the game over the cheaper non-enhanced bet options. If the player selects a pregame skill enhancement, a unique paytable associated with the selected enhancement may be used to settle the wager. Typically, the special paytable could carry a higher max return to player (RTP) than the lower base bet options offered by the game.

An example of a pregame skill enhancement in a match-3 style game may include selling the player a “super bomb” for 50 additional credits that doubles the board clearing power of any bombs activated during the subsequent skill game.

Dynamic Skill Enhancements

Dynamic pregame skill enhancements may function similarly to pregame buy-a-boosts with some differences. In particular, dynamic skill enhancements may be offered to the player dynamically during a session to help the player address a current roadblock or challenge (for example, as a pop-up offer made by the game). In some cases, depending on game type, these skill enhancements may not be associated with a unique paytable. In cases where no special paytable is called, the full value of the skill enhancement exists in increasing the player's chance of success in the skill-based challenge in which the skill enhancement is offered.

An example of a dynamic skill enhancement in a match-3 style game may include selling the player a “5 extra moves” for 25 additional credits at the end of a game in which the player has not met his or her level objective/objectives. In the example of skill-based challenges.

Mystery Skill Enhancements

Mystery skill enhancements increase a player's in-game abilities and may be awarded to the player over the course of play. In some cases, these skill enhancements may be randomly awarded to the player and in other cases the award of the skill enhancement may be scripted (e.g., a certain skill enhancement may always be awarded at a set point in the game's progression or narrative). Since these skill enhancements are not purchased by the player they are not a revenue stream.

An example of a mystery skill enhancement in a narrative style game would be encountering a treasure chest on the game's map that opens to reveal a “do over” card which can be played at any time to erase a bad game performance and try again for free.

Wager Performance Enhancements

Games according to some embodiments described herein have a two-phase design including a skill-based challenge followed by a chance-based game that is influenced by the player's performance in the skill-based challenge. Better performance in the skill-based challenge gives the player better odds in the chance-based game. As an example, playing well in a match 3 style game may earn the player more picks in a traditional pick bonus that occurs afterward where the full payout is awarded. This kind of game design provides the opportunity to offer players a new form of enhancement that is unique to regulated gaming: the wager performance enhancement. Wager performance enhancements give the player the ability to manipulate the random chance-based game and turn the odds on their favor. In some embodiments, wager performance enhancements may be randomly awarded to players instead of purchased.

An example of a wager performance enhancement in a pick game would be randomly awarding the player a “beacon boost” before the pick game that allows the player to see the highest value award in a pick layout, thereby allowing the player to make a perfect pick and increasing his or her chances of obtaining a reward. Other wager performance enhancements may be made available to the player, such as “Lo-Show,” “Re-Pick,” “Preview” and other wager performance enhancements. “Lo-Show” shows the player the 3 lowest prizes in a pick grid so that they can be avoided. “Re-Pick” gives the player the opportunity to erase a pick and pick again. “Preview” lets the player see the value of a selection item in the pick grid before deciding whether to pick it. It will be appreciated that the foregoing list of wager performance enhancements is non-exhaustive.

In some embodiments, the EGM 100 may include a display area in which the player can view skill enhancement activity on their account. This area may be accessible from an in-game wrapper, a casino launch application, an operator portal, or through some other feature. The player may be able to see skill enhancement activity in the form of active skill enhancements and consumed skill enhancements. Each skill enhancement may show and be filterable by the following information: (i) a description of skill enhancement attributes; (ii) a date of consumption of the skill enhancement—when it was used by the player; (iii) a cost of purchase; (iv) an associated game—e.g., which game the skill enhancement is for; (v) a bet increment/wager requirement for use—some skill enhancements will be bought for a price related to the wagering amount when buying a game round/spin, and players may be only able to use certain pre-game skill enhancements at certain bet levels; (vi) a source of the enhancement—e.g., whether it was promotional, purchased, game awarded; and (vii) a power rating (1-5)—how powerful the skill enhancement is.

In some embodiments, players may receive notifications in the form of graphical visualizations when they attain a skill enhancement. Players may need to “claim” a skill enhancement as a form of acknowledgement of the award.

In some embodiments, users may be shown a visual representation to acknowledge when they have obtained a skill enhancement. The visual representation may be graphical, and may be animated or static.

In some embodiments, the EGM 100 may communicate with the player tracking server 45 to determine if the player is entitled to a persistent skill enhancement. A persistent skill enhancement may be used by the player any time the player plays the hybrid game described herein. In various embodiments, the persistent skill enhancement may be associated with a particular EGM 100, with any EGM offering the game in a particular location, with any EGM offering the game that is operated by a particular gaming operator or affiliated group of operators, and/or with any EGM operating the game anywhere.

Accordingly, the persistent skill enhancement is usable by the player in the skill-based challenge and in subsequent plays of the skill-based challenge. The persistent skill enhancement is usable by the player in subsequent plays of the skill-based challenge on different EGMs, including EGMs located on different premises from the EGM 100 and in some embodiments in subsequent plays of the skill-based challenge on different EGMs operated by different casino operators.

Once the EGM 100 has determined that the player is entitled to the persistent skill enhancement, the EGM 100 initiates play of the skill-based challenge or game including the persistent skill enhancement (block 306). The skill-based challenge or game may be a game that involves an aspect of skill on the part of the player. The skill-based challenge or game may also involve an element of chance; however, an outcome of the skill-based challenge may be affected by the persistent skill enhancement. Various types of skill-based challenges and games are described below. Briefly, the skill-based challenge or game may be any game that requires or involves skill, such as a game that rewards speed, accuracy, knowledge, strategy or the skill-based challenge or game can include an arcade-style skill game such as Breakout®, Space Invaders® or Pac-Man®, a “match” type game in which a player attempts to match symbols in groups of two or more, a card game, such as Solitaire, that involves a level of skill, etc. The persistent skill enhancement may include any modification to the game that increases the player's chance of winning, successfully navigating a level, clearing a board, etc.

In particular embodiments, in the skill-based challenge, the EGM 100 may display a gameboard including multiple game elements arranged in a matrix. The EGM may receive a selection from the user of a subset of the multiple game elements, and may award points to the player when the selected subset of the multiple game elements includes at least two similar game elements that are adjacent to one another on the gameboard. Additional points may be awarded when larger numbers of adjacent game elements are selected. Moreover, the game elements may disappear when selected, and the matrix may be refilled with new randomly generated game elements. Additional points may be awarded, for example, for clearing an entire board, clearing game elements of a particular color, and/or performing some other in-game challenge. Moreover, in some embodiments, instant awards in the form of credits or other compensation may be awarded to the player in response to an in-game accomplishment.

In some embodiments, before the skill-based challenge is initiated, the EGM 100 may present to the player a set of avatars, characters or other virtual items that represent the player during play of the skill-based challenge. The player may select an avatar, character or other virtual item for use in the skill-based challenge. In some embodiments, the persistent skill enhancement may include an upgraded avatar, character or other virtual item that provides a skill enhancement to the player while playing the skill-based challenge.

In response to an outcome of the skill-based challenge, the EGM 100 awards the player at least one entry into a chance-based prize round, wherein a probability of winning the chance-based prize round may be enhanced based on the outcome of the skill-based challenge (block 310). For example, the player may be awarded a number of spins, entries, tries, lives, etc., in the chance-based prize round based on the outcome of the skill-based challenge, and in some embodiments, based on an evaluation of the player's skill in playing the skill-based challenge.

In some embodiments, the player may be awarded an entry into a separate game, such as a progressive jackpot game or a wide area progressive (WAP) jackpot game in response to the outcome of the skill-based challenge. Wide area progressive jackpot systems are described in more detail below. The skill-based challenge may include multiple levels, and as the player advances through multiple levels, the player may be awarded eligibility for and/or entries into different wide area progressive jackpot games. The progressive jackpot may be a must-hit-by progressive jackpot game. In a must-hit-by progressive, the jackpot starts at a defined minimum amount. A point at which the jackpot will hit is randomly chosen on a uniform distribution between the starting value and a maximum possible jackpot. A certain percentage of money bet on the game is directed towards the jackpot. The amount directed towards the jackpot is referred to as the “meter.” When the meter crosses the predetermined win point, the player will be awarded the jackpot.

In some embodiments, the player may be awarded an entry into a separate skill-based challenge, such as a wide area skill based game in response to the outcome of the skill-based challenge. A winner of the wide area skill based game may be awarded a prize from a wide area progressive jackpot, as will be described in more detail below. The wide area skill based game may be played against other players or in collaboration with other players in real time or in turn-based scenarios.

For example, in some embodiments, the EGM 100 may receive a notification from a wide area progressive server that a jackpot is ready to be awarded in a wide area progressive game. The EGM 100 may initiate play of a wide area skill-based challenge against players of other gaming systems who are eligible to participate in the wide area progressive game, and may notify the player that the player has won or not won the jackpot in response to an outcome of the wide area skill-based challenge. In some embodiments, the persistent skill enhancement is usable in the wide area skill-based challenge. The wide area skill-based challenge may be available across all gaming devices that are participating in the game.

In still further embodiments, as part of the skill-based challenge, the EGM 100 may present a plurality of play levels to the player, wherein each play level has an associated gameboard including a plurality of game elements and rules, and wherein each play level is associated with one of a plurality of game areas such that the player completes the play levels, the player advances through successive ones of the game areas. At least one of the plurality of game areas may be associated with a progressive jackpot game, and the player must complete the at least one of the plurality of game areas to be qualified for the progressive jackpot game.

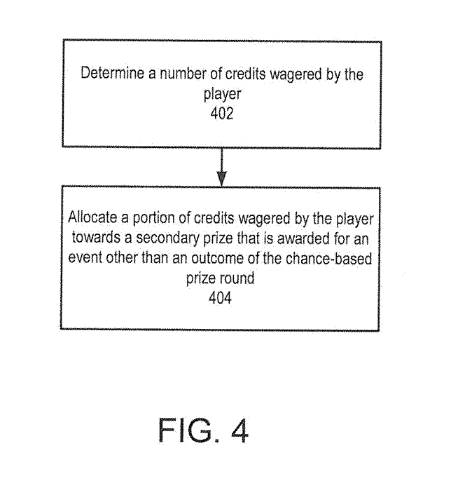

A portion of the player's wager may be allocated towards paying the wide area progressive jackpot. Accordingly, referring to FIG. 4, in some embodiments, the EGM 100 may determine a number of credits wagered by the player (block 402), and allocate a portion of the credits wagered by the player towards a secondary prize that is awarded for an event other than an outcome of the chance-based prize round (block 404). In some embodiments, the portion of the credits allocated towards the secondary prize is determined in response to the evaluated skill level of the player. Thus, in some embodiments, the better the player performs, the less of the player's wager is allocated towards the wide area progressive jackpot. This may allow the EGM 100 to use a paytable for the player's chance-based prize round that has a higher RTP.

In some embodiments, the secondary prize is allocated to be awarded in response to an event in the skill-based challenge. In other embodiments, the secondary prize is allocated to be awarded in response to an instant win event in the skill-based challenge.

Referring again to FIG. 3, the EGM 100 then initiates the chance-based prize round (block 312), and determines (block 314) if the player won the chance-based prize round. The chance based game may have many different forms, as discussed in more detail below. Briefly, the chance-based prize round may be a game having an outcome determined by a random number generated by random number generator 20H (FIG. 1C). In some embodiments, the outcome of the chance-based prize round may be determined in response to an action or selection by the player. If the player wins the chance-based prize round, the EGM 100 may award a monetary prize to the player (block 316).

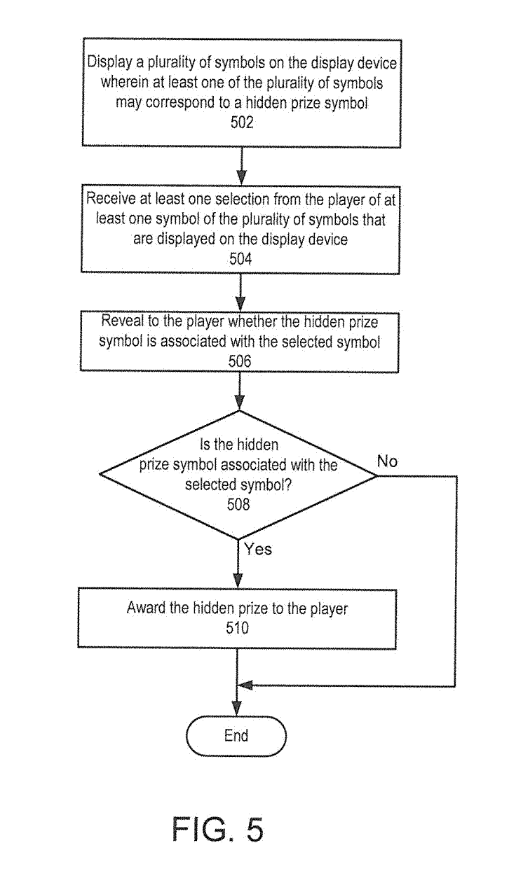

FIG. 5 is a flowchart illustrating an operation of the chance-based prize round according to some embodiments. Referring to FIG. 5, in some embodiments, the chance-based prize round is a hidden prize game in which the EGM 100 displays a plurality of symbols on the display device 116, 118, wherein at least one of the plurality of symbols corresponds to a hidden prize symbol that has an associated hidden prize (block 502). The player selects at least one of the symbols that are displayed on the display device (block 504). In response to the selection, the EGM 100 reveals to the player whether the hidden prize symbol is associated with the selected symbol (block 506). If it is determined at block 508 that the hidden prize symbol is associated with the selected symbol, the EGM 100 awards the hidden prize to the player (block 510).

In some embodiments, the player may be allowed to make multiple selections of symbols. In particular, the player may be permitted to make additional selections based on the player's performance in the skill-based challenge.

Game Description

Some embodiments of the inventive concepts will now be described in the context of a game referred to herein as “Dragon Game.” Dragon Game is a hybrid game including a skill-based challenge followed by a chance-based prize round in which the outcome of the chance-based prize round can be affected by a player's performance in the skill-based challenge. It will be appreciated that Dragon Game is provided as an example embodiment of the inventive concepts described herein, and that the inventive concepts can be embodied in many different games.

The object of the skill-based challenge portion of Dragon Game is for a player to navigate through a series of progressively more difficult levels of gameplay until the player has completed an ultimate challenge. To complete a level, the player chooses an avatar, character or other virtual item to represent them in the game. A number of different avatars, characters or other virtual items may be available to the player, and each of the avatars, characters or other virtual items may have special skills or abilities that give the player an advantage during the game. The collection of avatars, characters or other virtual items that are available for selection by the player may depend on the player's past performance in the game and/or on whether the player has purchased one of the avatars, characters or other virtual items as a persistent skill advantage.

Upon completion of a level, the player's level of skill in completing the level is evaluated, and the player is presented with a chance-based prize round that gives the player an opportunity to win a prize, such as a monetary prize.

The levels of Dragon Game are set in a virtual world called Dragonia. Dragonia is divided into a number of areas, referred to generically as Areas A to E. Areas A through D may have names, such as “Lilac Valley,” “Mystery Lake,” “Crystal Caverns,” “Fire Mountain,” and “Mystery World.” One or more of the areas may have an associated progressive jackpot, such that when the player enters or completes the area, the player may be eligible to participate in the associated progressive jackpot. In some embodiments, the player may be automatically entered into the progressive jackpot game when the player enters or completes the associated area.

In Dragon Game, Lucky is a young dragon who lives with his mother Venus in Dragonia. However, Lucky is threatened when the Star Dragon swoops down and steals Venus away. The Star Dragon, which is formed as a gigantic constellation in the sky, steals dragons from Dragonia to turn them into stars and harness their energy for dark magic. Every time the Star Dragon turns a dragon into a star, that star becomes a part of him, and he grows in power. In Dragon Game, Lucky's mission is to fight dark magic through gathering beautiful items (coins, crystals, etc), to assemble a small but skilled dragon army, and to journey from the Lilac Valley to Fire Mountain and then up into the sky to ultimately confront the Star Dragon and rescue his mother. On the way, the player may choose one of the dragons from his dragon army to serve as his avatar or character while completing a level.

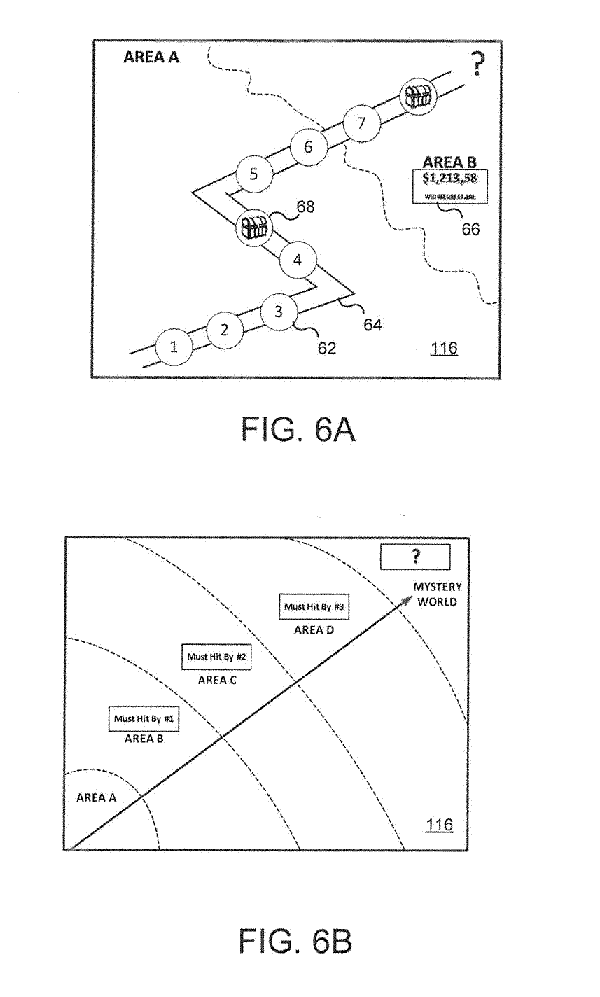

Dragon Game begins when a player wagers a wager amount to play the game. A map, such as the map shown in FIG. 6A, is shown to the player on the display device 116. The map shown in FIG. 6A includes a number of levels 62 (1-7) along a path 64 from Area A to Area B. The map also shows a progressive jackpot amount 66 associated with Area B. The progressive jackpot may be a wide area progressive jackpot that allows players located at different locations to participate. Wide area progressive jackpot games are described in more detail below.

The player starts at level 1 in Area A. When the player successfully completes levels 1-6, the player enters Area B and becomes eligible for the progressive jackpot game associated with Area B. Along the path are a number of bonus prizes 68 that may be won when the player completes a predetermined level. The progressive jackpot may be a “must hit by” jackpot that must be won before it reaches a predetermined jackpot level. However, it will be appreciated that the progressive jackpot may not be a “must hit by” progressive jackpot.

FIG. 6B illustrates a broader map showing Areas A to E through which the player can progress as the player completes levels. As shown in FIG. 6B, in one example, some but not all areas have an associated progressive jackpot. In some embodiments, all areas may have an associated progressive jackpot, and in other embodiments, only one area may have an associated progressive jackpot.

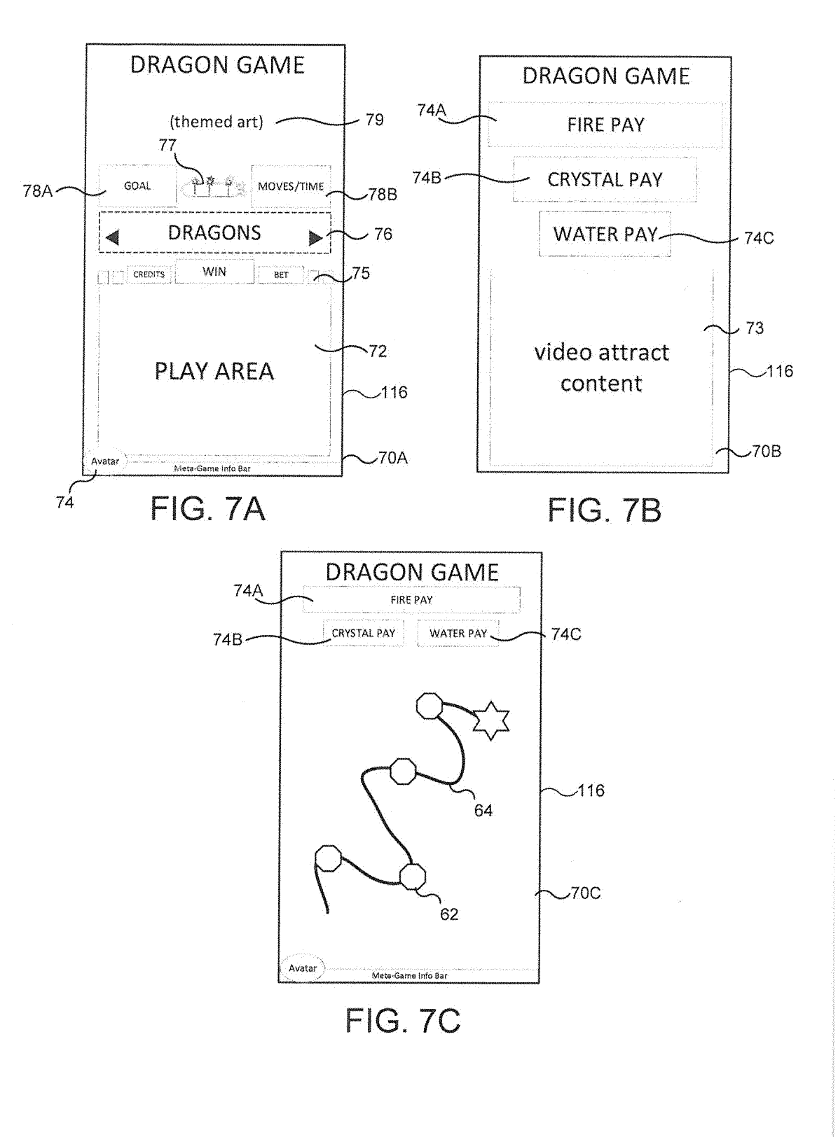

Display screen layouts for various stages of operation of the EGM 100 are illustrated in FIGS. 7A to 7C. The screen layouts shown in FIGS. 7A to 7C may be displayed on the primary display device 116 of the EGM 100, which may have a high aspect ratio.

For example, FIG. 7A illustrates a screen layout 70A that may be presented during gameplay of the skill-based portion of Dragon Game. The screen layout 70A includes a play area 72 where various game elements are displayed. Below the play area 72, an avatar 74 of the player may be displayed. The avatar may in some embodiments be a currently selected one of the dragons or portion thereof. In some embodiments, the avatar may be modified to include an image corresponding to the player, the player's clothing, hairstyle, etc. An informational area 75 above the play area 72 displays a number of credits and a current bet amount. The dragons that are available for use by the player are displayed in a dragon display area 76. A game informational area displays a current game goal 78A and a remaining moves/time tracker 7813. A themed artwork area 79 may be provided in an upper portion of the display screen.

FIG. 7A also includes a rating bar 77 that displays a rating each time the player completes a level. In the illustrated embodiment, the rating is indicated by a number of stars that are awarded to the player based on the player's performance in completing the level. The number of stars awarded to the player may be based, for example, on a number of points awarded to the player while playing the level, the amount of time needed to complete the level, the number of moves needed to complete the level, or any other relevant factor.

FIG. 7B illustrates an attract mode layout 70B that may be displayed when no player is currently using the EGM 100. The attract mode layout 701 includes a large video attract content area 73, and may also display a plurality of paytables 74A-C that may be used depending on the level of wager placed by the player.

FIG. 7C illustrates a map layout 70C that displays the player's current progress in the game. The map includes at least some of the available levels 62 and a path 64 from level to level. The map layout 70C may also display the paytables 74A-C.

1. Skill-Based Challenge

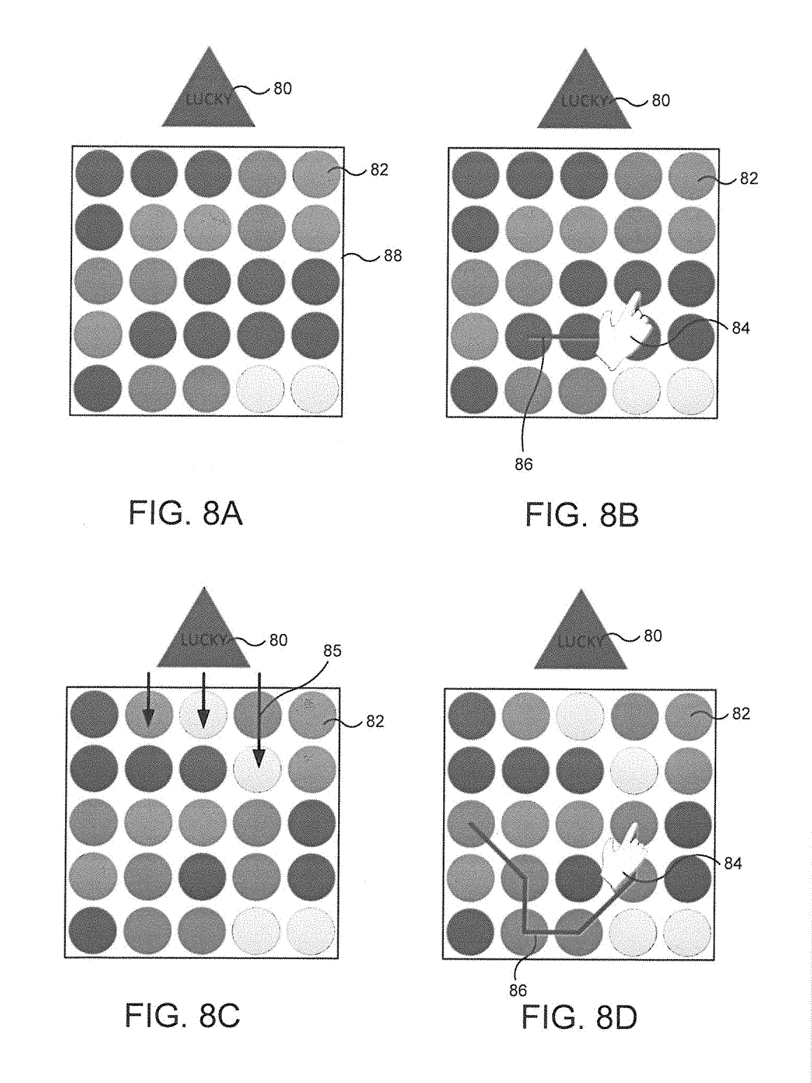

FIGS. 8A to 8D illustrate various configurations of game elements that may be displayed in the play area 72 during gameplay of the skill-based challenge. For example, FIG. 8A illustrates a play area 72 including a matrix 88 of game elements 82 that may be displayed on the primary display device 116. Although illustrated in FIG. 8A as patterned circles, the game elements 82 may have any shape or form, including jewels, flowers, animals, stars, etc. An avatar 80 is positioned above the matrix 88. The avatar 80 may be the selected dragon that the player is using to play the current level. The game elements 82 may in some embodiments be displayed in 3D to the player.

Referring to FIG. 8B, a player may score points by selecting matching game elements 82 that are adjacent to each other. For example, the player may use their hand or finger 84 to select matching game elements 82 by touching one of the game elements and dragging their finger across the matching game elements. In some embodiments, the player may interact with the matrix 88 by touching a touchscreen display. In other embodiments, a motion tracking camera may be used to track the player's hand or finger, and the player may interact with the game elements without touching a touchscreen or other physical input device.

In other embodiments, the player may cause game elements to be arranged in matching pairs or triplets by swapping adjacent game elements with each other.

Referring to FIG. 8C, when a player has matched adjacent game elements by, for example, selecting them as shown in FIG. 8B, the game elements may disappear. Game elements above the disappeared game elements may slide down and take their places, and new game elements may appear and slide down into the newly vacated matrix positions. The new game elements may be randomly generated. As shown in FIG. 8D, matching game elements 82 may be adjacent in positions that are left, right, above, below or diagonal from one another.

When a level begins the player is given one or more objectives, which may be randomized within certain parameters. Different objectives are possible such as (a) achieve a score of at least X in Y moves or less, (b) achieve a score of X in Y seconds or less; (c) clear X game elements; drop X items through the bottom of the screen. As in traditional match games, making special matches may generate special features with greater board clearing power. For example, making a match of four or more game elements may cause a special dragon or item to appear that can clear more game elements.

Over the course of play, the player will collect and upgrade characters that have the power to increase the player's winning chances by performing boost events during gameplay. Before each level, the player may choose one available character to use on the upcoming level. Players will also have the ability to use more than one character on a single level if they have previously bought boosts or wish to spend extra credits. The player will start the game with at least one character and may earn additional characters as the game unfolds.

Characters in the game may include good dragons, evil dragons and mercenary dragons. The good dragons may be chosen by the player as avatars. Each good dragon may have an associated skill, ability or effect that can help the player complete a given level. For example, the good dragons may include:

LUCKY—A young purple dragon who is the hero of the game. Players upgrade Lucky from a child to a powerful dragon over the course of play. Lucky gets a score bonus for all purple matches. Lucky also has an additional special power: when used he wins more random in-game items than the other dragons, which is how he got his name. With upgrades Lucky develops transformer abilities. In some embodiments, a transformer ability is the ability to create a special game element that can transform adjacent game elements into the same color. This special game element might automatically transform adjacent elements when it is included in a matching outcome. Adjacent elements could include all elements that are adjacent in the 4 orthogonal directions and/or the 4 diagonal directions. This special game element could appear on screen after fulfilling a particular requirement such as (i) making a certain number of matches, (ii) making a match of a certain number of game elements, (iii) making a certain number of matches of one color, or (iv) making a number of matches of one color where the number of game elements in those matches is accumulated until it reaches a particular threshold. This special game element could drop in from above or appear randomly on screen at any suitable location. In other embodiments, a transformer ability is the ability to transform all game elements in one region on screen into game elements of one color. This region could be one or more rows, one or more columns, a square or rectangle shape of any suitable size, or any other suitable shape or size. This transform ability might happen randomly after fulfilling a particular requirement (see requirements above for other embodiment) or the player might get to choose the affected region. In another variation for both embodiments, the degree of power of the transformation could depend on the player's level. For example, in the first embodiment, the special game element may only transform the four orthogonally adjacent elements if the player is level one, but later when the player is level ten, the special game element may transform the four orthogonally adjacent and four diagonally adjacent game elements. For example, in the second embodiment, the size of the affected region may only be one row or one column if the player is level one, but later when the player is level ten, the size of the affected region is two rows or two columns.

WILLOW—A yellow female dragon. Willow starts out as a newly born dragon, like Lucky. Willow gets a score bonus for all yellow matches, making her useful on levels with lots of yellow symbols and levels in which the player must make a certain number of yellow matches to advance. With upgrades Willow develops transformer abilities.

CRUX—A tiny male star dragon that has escaped from the sky and secretly returned to Dragonia. Crux is useful for night levels where he earns a core multiplier for matches that the terrestrial dragons are ineligible for.

PYRO—Pyro is a baby red dragon with immediate bomb abilities. Pyro also gets a score bonus for red matches. With upgrades Pyro's bombs become more frequent and powerful.

AVA—A green female dragon. Ava gets a score bonus for all green matches. Ava starts out as a teenage dragon. With upgrades Ava develops horizontal clear abilities.

MILO—A blue male dragon. Milo gets a score bonus for all blue matches. Milo starts out as a teenage Dragon. With upgrades Milo develops vertical clear abilities. Additionally Milo is Ava's boyfriend. If used together, Ava and Milo give the player one free “hypercube” at the start of the level as a bonus.

SONICA—A second star dragon who is female and much larger and more powerful than Crux. Sonica is useful for night levels.

BRUTUS—a hulking pink male dragon. Born pink, Brutus overcompensates with an overly brutish and macho demeanor. Brutus does extra damage in clearing obstacles. Additionally he provides a number of “hammer” style clears that increase as he is upgraded.

BUCKET—Bucket is a mangy old dragon who has no advertised powers whatsoever. He wears a rotten old bucket on his head. On the screen where the other dragon's abilities are proudly listed, Bucket's entry reads: “Bucket is old and tired.” However, Bucket does have a secret past and a secret power: He was once one of the mightiest dragons in the realm and a staunch enemy of dark magic. Luckily for the dragons of Dragonia, Bucket still has a little fight left in him. On boss levels Bucket does extra damage. Bucket cannot be upgraded, but players can purchase nicer buckets for his head through micro-transactions.

RUPERT—A rainbow colored runt dragon that is erratic and misbehaved. Rupert gives the player a random ability when used. On 1 in every 25 games Rupert gives the player no special ability at all. On 1 in every 25 games Rupert gives the player many special abilities all at once. With upgrades, the random abilities Rupert provides become better on average.

ALEXIS (Super Rare)—Alexis is a fierce warrior dragon. She is the most powerful dragon in the game (other than Festivus) for day levels.

VENUS—A massive dragon who is the mother of Lucky. Venus becomes a playable character if the player reaches Area #5. Venus cannot be upgraded.

MAXIMUS—Maximus is a wise old dragon who is the king of Dragonia. Occasionally Festivus arranges tournaments for dragons throughout the land to compete in for glory and prizes (such as progressive jackpots). When a progressive jackpot is triggered, eligible players will see a message from Maximus prompting them to compete and ineligible players will get a message telling them how to be eligible to complete next time. Maximus becomes a very rare surprise playable character if the player is able to advance deep into the Star Dragon levels and also gets lucky enough to win him. Maximus is usable in the Realm of the Star Dragon levels but his maximum value is achieved if he is taken back to the previous game areas to replay day levels.

As will be appreciated, the “good dragons” may have abilities, such as bomb, horizontal clear, vertical clear, hammer, hypercube, etc. Moreover, some good dragons may confer an additional bonus when objects of a particular color are cleared. Using a good dragon can help a player reach a goal faster or in a smaller number of moves and/or score more points on a board, resulting in the player obtaining a higher skill rating for the board. This can help the player in a number of ways, such as by conferring more picks or tries in the challenge-based prize round, helping the player achieve an instant win based on an occurrence during the skill-based challenge, and/or qualifying the player for entry into a progressive jackpot game. One or more of the good dragons may be purchased by the player as a persistent skill enhancement that can be used any time the player plays the game on the EGM 100 or on an affiliated EGM. Thus, for example, if the player has purchased the PYRO dragon, the player will be able to select the PYRO dragon to use as the player's avatar any time the player plays the hybrid game.

The evil dragons appear during the game and hinder the player's progress or performance. The evil dragons may include;

THE WATER DRAGON—An underwater dragon who guards Mystery Lake. The Water Dragon must be defeated to enter Area B and become eligible for the Water Progressive Jackpot. The Water Dragon breathes fire which instantly turns into coal. These coal bits fall into the game board blocking matches.

The CRYSTAL DRAGON—A subterranean dragon made from crystals who guards the Crystal Caverns. The Crystal Dragon must be defeated to enter Area C and become eligible for the Crystal Progressive. The Crystal Dragon is good at locking symbols inside crystals, forcing the player to break the crystals to free and clear them.

The FIRE DRAGON—A dragon made from flames who guards Fire Mountain. The Fire Dragon must be defeated to enter Area D and become eligible for the Fire Progressive. The Fire Dragon creates lots of pesky lava that must be dealt with before it spreads.

The STAR DRAGON—A massive evil dragon made from stars that resides in the night sky and steals dragons from Dragonia and turns them into stars to harness their energy for dark magic. The Star Dragon must be defeated to enter the mystery world, Area E, which is known as the Realm of the Star Dragon.

Mercenary dragons may, if available, be activated during gameplay to perform certain effects, such as granting the player extra moves or time on a level, or to shuffle the objects on a level.

The purpose of the dragon characters is to humanize the game play experience and give the player items—some rare—to covet during play. Some of the characters may have multiple upgrade levels that may be purchased or won. For example, the player may win or purchase in-game currency to promote their characters to the next level. When characters are upgraded, they develop greater, more powerful abilities to help the player. Although described in the specific example of dragons, the scope of the inventive concepts may include embodiments with any type and/or combinations of real and/or fictional objects, characters and/or environments.

During play of the base game, larger matches may generate instant win opportunities for the player. In these cases, the player will see a credit value appear onscreen at the time a match is made and those credits will be added to the player's win meter. Credits awarded for instant wins may be sourced from two buckets: base value credits that are built into the original math of the game and skill credits that are sourced from unwon credits left behind by previous players who played sub-optimally.

The grading, or skill evaluation, may be based on a number of factors. For example, meeting a level's base objectives may earn the player one star. Meeting a level's objectives and exceeding a predetermined amount of points may earn the player two stars. Meeting a level's objectives and exceeding a higher predetermined amount of points may earn the player three stars. Meeting a level's objectives, exceeding a higher level of predetermined amount of points, and successfully collecting a rare item during play may earn the player four stars. It will be appreciated that many other bases for grading performance may be used. Moreover, the bases for grading the player's performance may vary from level to level.

Depending on the skill grading awarded to the player (e.g., zero to four stars), the player is given some number of picks, entries, tries, and/or lives in a chance-based prize round that is played following the conclusion of the skill-based challenge.

A portion of credits wagered by players earning less than three stars may be redistributed into the game. These credits may increase the value of Instant Win opportunities, Progressives, and prizes offered during the prize round such as the Super Award Progressives.

2. Chance-Based Prize Round

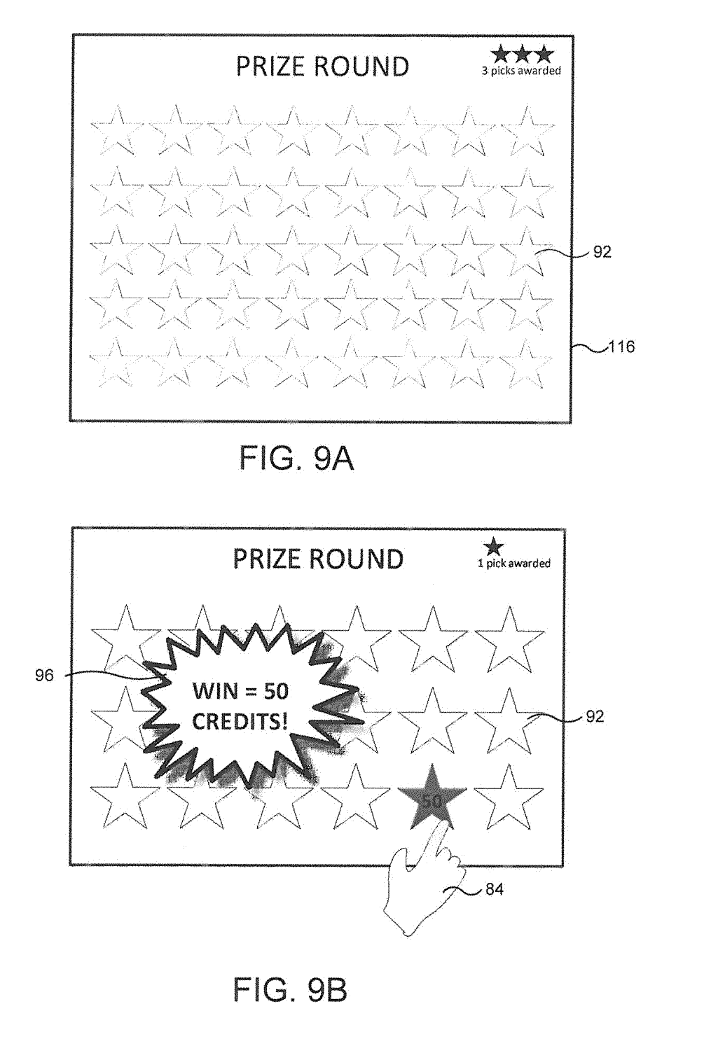

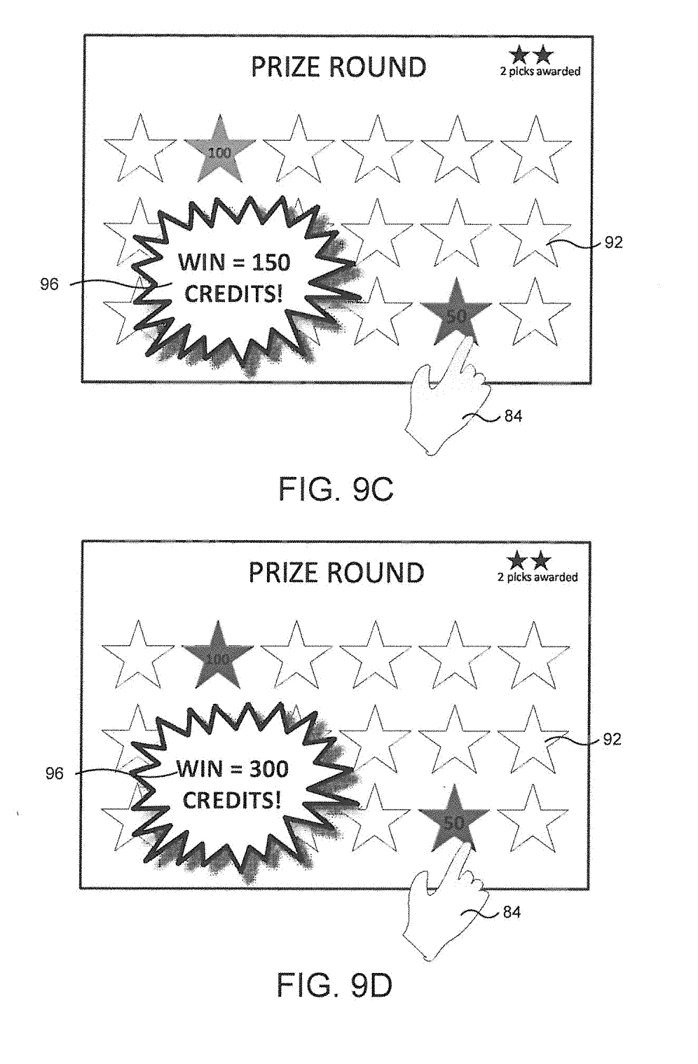

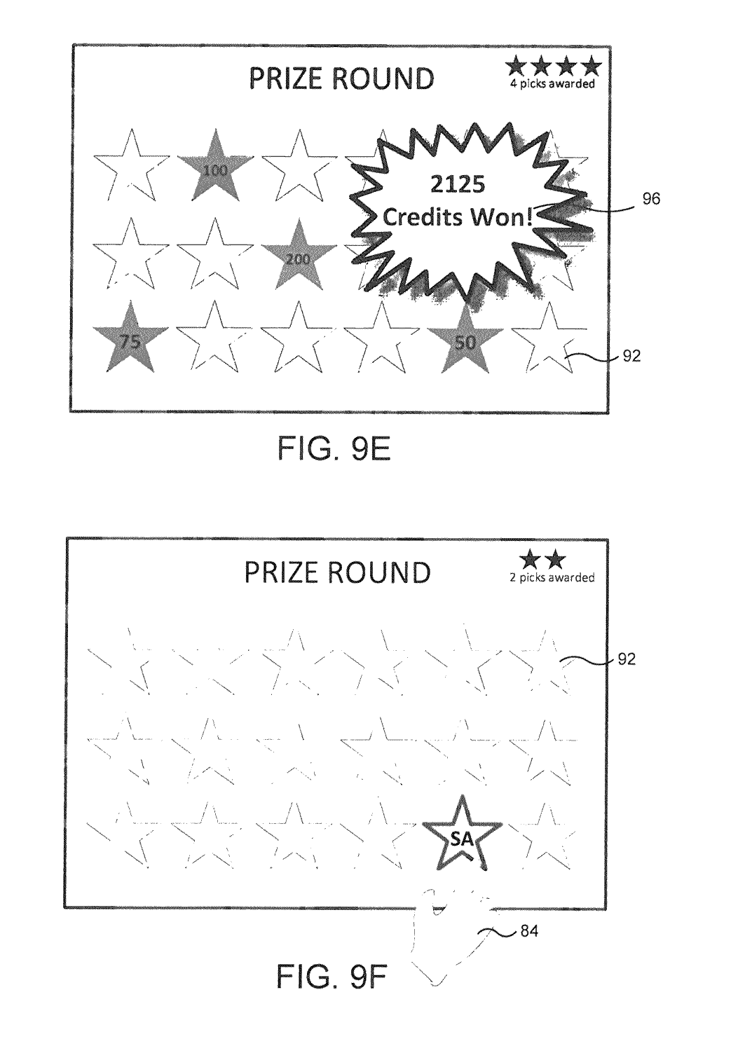

Referring to FIG. 9A, in the chance-based prize round in Dragon Game, the EGM 100 displays a matrix 94 of symbols 92, such as the stars shown in FIG. 9A, in the game play area 72 on the primary display device 116. The EGM 100 also displays the number of picks that have been awarded to the player based on the skill grading awarded to the player at the conclusion of the skill-based challenge round. In the embodiment illustrated in FIG. 9A, the player has been awarded three stars, and therefore receives three picks in the chance-based prize round. Although the symbols 92 shown in FIG. 9A are all the same, in some embodiments the matrix 94 may include different symbols. One or more of the symbols 92 in the matrix 94 may be associated with a hidden prize. If the player selects the symbol associated with the hidden prize with one of their picks, the hidden prize is revealed to the player, and the player wins the hidden prize.

For example, referring to FIG. 9B, the player selects a star symbol 92 that is associated with a prize of 50 credits. A pop-up message 96 is displayed on the screen, and the player is awarded the prize of 50 credits.

If the player has been awarded multiple picks, it is possible for the player to select multiple winning symbols, as shown in FIG. 9C. In the example shown in FIG. 9C, the player has selected a first symbol corresponding to a hidden prize of 50 credits and a second symbol corresponding to a hidden prize of 100 credits. The player may then be awarded the combined award of 150 credits.

In some embodiments, the symbols 92 may also have associated hidden colors or other properties that are revealed when the symbols are selected. If two hidden colors for two prize-winning symbols match, the total amount awarded to the player may be increased. Referring to FIG. 9D, the player has selected a first symbol corresponding to a hidden prize of 50 credits and a second symbol corresponding to a hidden prize of 100 credits. When the hidden prizes are revealed, it is also revealed that the two selected hidden symbols 92 have the same hidden color. Thus, the player's award is doubled to 300 credits.

Picking more symbols with the same hidden color may result in larger multipliers of the award (e.g., three matching colors results in 3× multiplier, four matching colors results in 4× multiplier, etc.), as shown in FIG. 9E.

In some embodiments, Super Award stars are also available, as illustrated in FIG. 9F, in which a Super Award star labeled “SA” is revealed after it is selected. For example, in one embodiment there may be four Super Award progressives. Picking one Super Award star may award the first Super Award progressive, picking two Super Award stars may award the second Super Award progressive, picking three Super Award stars may award the third Super Award progressive and picking four Super Awards stars may award the fourth and largest Super Award value. Many other variations are possible. For example, the player may be required to match two award amounts in order to win an award.

In addition to the credit prizes listed above, in game currency awards will also be offered. This currency is used to advance character levels and unlock game features.

This feature of play may allow the game to essentially have no zero-win outcomes in the prize round. Players will either win money or valuable in-game currencies, boosts, and advantages. This mechanism may offer a strong positive reinforcement proposition provided that players value the non-credit awards.

Special items and powers can be earned or won in the game that may improve the player's chances during the Prize Round including the following:

Preview—See an element's value or color without committing a pick;

Color Swap—Change the color of a selected item;

Mulligan—Undo a pick;

Upgrade—Automatically removes the 3 lowest value prizes from the layout; and

Beacon—Automatically selects the highest value item.

3. Progressive Jackpot Awards

Starting at Area B, each Area in the game has a progressive jackpot game associated with it. The progressive jackpot game may be a “must hit by” or other type of progressive jackpot game, and in some embodiments may be a wide area progressive jackpot game. These progressive jackpot games may be funded by a combination of coin-in and by unwon skill credits. Because the player is eligible to win the progressives of all levels the player has reached, a strong incentive is created for the player to travel further along the game's map.

In some embodiments, the progressive jackpot games may be designed such that the progressive jackpot can be awarded at any value, but the probability of it awarding increases as it approaches a predetermined value.

The three Progressives are as follows:
The Water Progressive
The Crystal Progressive
The Fire Progressive

Whenever a progressive is triggered, the system polls all active players on all EGMs 100 that are playing Dragon Game to determine eligibility. Bonus eligibility may be determined based on a formula that takes into account the following factors:

Game Progress—Players are only eligible for progressives that are associated with Areas in the game they have reached. If the player is in the game's first Area (Area A—Lilac Valley) the player is not eligible to win any progressives. If the player is in the game's last Area (Area E—Realm of the Star Dragon) the player is eligible for all three progressives.

Once the player has been determined bonus eligible from a progress standpoint, the game will use a traditional eligibility formula that takes into account bet size and bet frequency. The player's current eligibility status may be communicated based on a simple Yes/No meter that toggles between Eligible (Yes) messaging and Ineligible (No) messaging and that may also incorporate a circular countdown meter that shows the player's status progressing from Yes to No over time. In some embodiments, the player's avatar icon may be used as this meter, for example by having a green background for eligibility=Yes and a red background for eligibility=No, with the countdown meter encircling the Avatar.

4. Wide Area Skill-Based Challenge

When the progressive jackpot game logic determines that the progressive jackpot is due to be won, the games of all eligible players may be interrupted by a winning opportunity message. Then all players on the EGMs can play a brief skill tournament to determine who wins the progressive value. The skill tournament may involve playing one of the levels of the skill-based challenge portion of the game. However, other types of skill-based challenges may be used. The skill tournaments may also include an element of chance so that even a novice or unskilled player has a chance of winning through good fortune. In some embodiments, a persistent skill enhancement belonging to a player may be used in the wide-area skill-based challenge.

Skill Gaming Boosts

Embodiments of the inventive concepts described herein employ persistent skill enhancements that can be purchased by a player and that can be re-used in subsequent gaming sessions. These skill enhancements are sometimes referred to as “boosts.” Boosts may provide an important driver for adoption and retention of players of wagering games that have a story or narrative driven progression (SDP). In general, a boost is anything that influences a game's outcome in the player's favor. This may include an ability upgrade, a tool, a feature, or any other property or item that improves player performance. In a single player mode this may influence the outcome against the random number generator/CPU. In a multiplayer/tournament/community mode this could affect another “less progressed” player's outcome to benefit the user of the boost in a competitive environment. A boost can also benefit other player's outcomes in a cooperative or team environment.

In some cases, a boost may unlock levels or zones that have new, different features.

In some embodiments, a boost may include something that provides emotional or social value to a player that does not have any effect on the player's ability to perform in the game, such as visual/custom upgrades to their in-game characters, new skins, bonus levels that are re-skins of already playable levels, characters that are re-skins of existing characters, etc.

When achieved/unlocked/purchased/awarded, boosts are stored against a players account and should be active across channels in the same game. In particular embodiments, once a boost has been unlocked, the boost is permanently active for that player in a specific game.

Some boosts can be purchased in the game or outside the game. Some boosts can be awarded as a “comp” as part of a player loyalty program.

Wide Area Progressive Systems

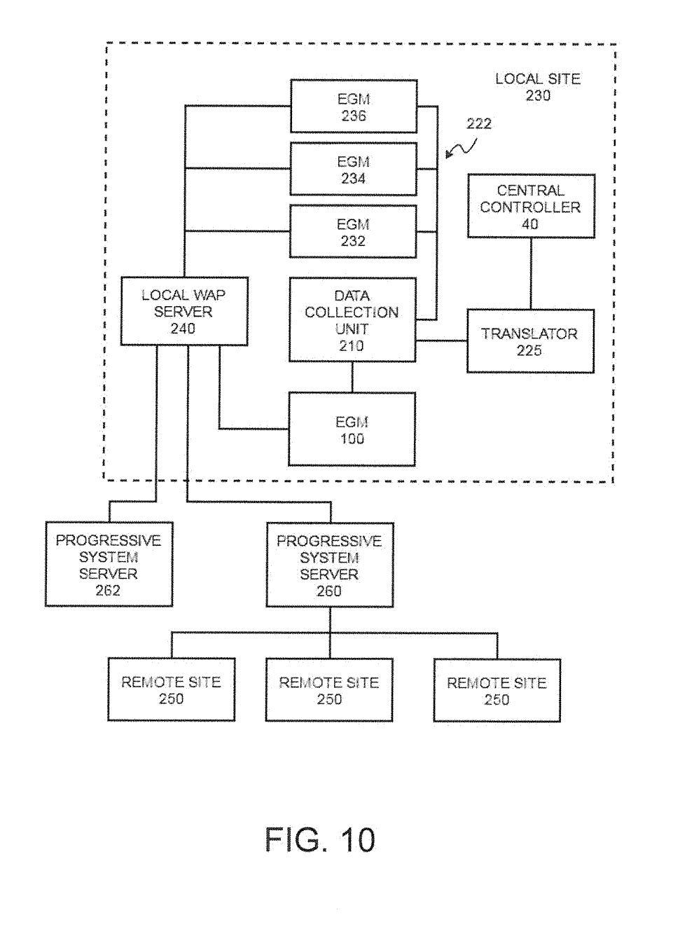

FIG. 10 illustrates an EGM 100 that participates in one or more wide-area progressive (WAP) jackpot games along with a plurality of other EGMs that may be located in different locations and that may offer the same game to players as the EGM 100. The participating EGMs may be connected in a progressive game network. The progressive game services enabled by the progressive game network increase the game playing capabilities of a particular gaming machine by enabling a larger jackpot than would be possible if the gaming machine was operating in a “stand alone” mode. Playing a game on a participating gaming machine gives a player a chance to win the progressive jackpot. The rate at which the jackpot grows increases as the number of gaming machines connected in the progressive network is increased. The size of the jackpot tends to increase game play on gaming machines offering a progressive jackpot. These types of games are referred to as “progressive games.” A jackpot that must hit by a certain threshold is referred to as a “must hit by progressive game.”

In a progressive jackpot game according to some embodiments, a portion of each wager on a game of chance played on the EGM 100 is contributed to a wide area progressive jackpot. The EGM 100 may be configured to participate in multiple different wide area progressive jackpot games. For example, as discussed above, an EGM 100 offering a hybrid skill/chance wagering game according to some embodiments may provide a player with the ability to participate in different WAP games depending on the level that the player has completed in the skill-based portion of the game.

An amount of a first wide area progressive jackpot and an amount of a second wide area progressive jackpot game that an EGM 100 participates in may differ from one another. Further, the probability of winning the first wide area progressive jackpot or the second wide area progressive jackpot may be different.

Each WAP jackpot game may be administered by a WAP system server that communicates over a data communication network with participating EGMs to provide progressive system services to the EGMs.

Referring to FIG. 10, a wide area progressive gaming system is illustrated in which a plurality of EGMs at geographically separated locations can participate in a wide area progressive jackpot game. The EGM 100 is located at a local site 230 along with other EGMs 232, 234, 236 that may participate in the WAP game. The local site 230 may correspond, for example, to a single gaming establishment at which each of the EGMs 100, 232-236 is operated. Each of the EGMs 100, 232-236 is managed by a central controller 40 (FIG. 2) at the local site 230. Each of the EGMs 100, 232-236 may be connected to the central controller 40 through a data collection unit (DCU) 210 and a translator 225. In some embodiments, the EGMs 100, 232-236 may be connected to the DCU 210 through a dedicated gaming network 222. In general, the DCU 210 functions as an intermediary between the different gaming machines on the network 222 and the central controller 40. In general, the DCU 210 receives data transmitted from the gaming machines and sends the data to the central controller 40. In some instances, when the hardware interface used by the gaming machine is not compatible with the central controller 40, a translator 225 may be used to convert serial data from the DCU 210 to a format accepted by the central controller 40. A plurality of DCUs 210 may be provided at the local site 230, and the translator 225 may provide this conversion service to multiple ones of the plurality of DCUs 210.

Further, in some dedicated gaming networks, the DCU 210 can receive data transmitted from the central controller 40 for communication to the EGMs 100, 232-236 on the gaming network 222. The received data may be communicated synchronously to the EGMs 100, 232-236 on the gaming network 222. Within a gaming establishment, the EGMs 100, 232-236 may be located on the gaming floor for player access while the central controller 40 is usually located in another part of gaming establishment (e.g. the backroom), or at another location.

Each of the EGMs 100, 232-236 shown in FIG. 10 is also connected to at least one local WAP server 240, which coordinates communication with one or more progressive system servers 260, 262 that are typically located at a remote location or locations. The local WAP server 240 manages communication of the EGMs 100, 232-236 with the progressive system servers 260, 262, monitors coin-in and payouts of the EGMs 100, 232-236 and sends a portion of received funds to the progressive system servers 260, 262 for inclusion in their respective progressive jackpots.

The local WAP server 240 may be used to route messages indicating contributions and eligibility status to different progressive servers. The local WAP server 240 may also be used in a polling scheme to route messages between different EGMs 100, 232-236 and different progressive servers 260,262.

Each of the progressive system servers 260, 262 administers at least one WAP game. Moreover, each of the progressive system servers 260, 262 may communicate with local WAP servers 240 at a plurality of geographically distributed locations, as illustrated in FIG. 10.

In one embodiment, an amount of a first wide area progressive jackpot may be maintained by progressive system server 260 and an amount of the second wide area progressive jackpot may be maintained by progressive system server 262. In some embodiments, a single progressive system server may maintain multiple wide area progressive jackpots. Thus, in another embodiment, the progressive system server 260 (or the progressive system server 262) may maintain both the first wide area progressive jackpot and the second wide area progressive jackpot.

The EGM 100 may be designed to display progressive jackpot amounts for each of the progressive games available for display on the EGM 100. For example, the EGM 100 may receive updates of a first progressive jackpot amount from the progressive system server 260 and a second progressive jackpot amount from the progressive system server 262. The progressive jackpot amounts may be displayed serially or concurrently with information describing the progressive game with which it is associated. The progressive jackpot amounts may be displayed on a display on or nearby the EGM 100.

In general, the functions of different devices shown in FIG. 10 may be combined or separated as is warranted by a particular gaming environment. For example, the central controller 40 may provide functions of one or more of a local WAP server 240, a DCU 210, and/or a translator 225.

In general, the dedicated communication network 222 over which the EGMs 100, 232-236 communicate may not be accessible to the public. Due to the sensitive nature of much of the information on the dedicated networks, for example, electronic fund transfers and player tracking data, usually the manufacturer of a host system, such as a player tracking system, or group of host systems, employs a particular networking language having proprietary protocols. These proprietary protocols are usually considered highly confidential and not released publicly. Thus, whenever a new host system is introduced for use with a gaming machine, rather than trying to interpret all the different protocols utilized by different manufacturers, the new host system is typically designed as a separate network. Consequently, as more host systems are introduced, the independent network structures continue to build up in the casino.

Further, in the gaming industry, many different manufacturers make gaming machines. The communication protocols on the gaming machine are typically hard-coded into the gaming machine software, and each gaming machine manufacturer may utilize a different proprietary communication protocol. A gaming machine manufacturer may also produce host systems, in which case their gaming machines are compatible with their own host systems. However, in a heterogeneous gaming environment, such as a casino, gaming machines from many different manufacturers, each with their own communication protocol, may be connected to host systems from many different manufacturers, each with their own communication protocol. Therefore, communication compatibility issues regarding the protocols used by the gaming machines in the system and protocols used by the host systems must be considered.

Communications between the local WAP server 240 and the progressive system servers 260, 262 may occur over public and/or private networks, and may include circuit switched and/or packet switched networks or sub-networks. Accordingly, communication sessions between the local WAP server 240 and a progressive system server 262, 264 may be authenticated, and the communications themselves may be encrypted for security.

Other Chance-Based Games

Although the chance-based prize round in the embodiments described above is a “symbol matching” game, it will be appreciated that the wagering game may be any suitable chance-based prize round in electronic or electromechanical form. For example, the chance-based prize round may comprise any suitable reel-type game, card game, cascading or falling symbol game, number game or other game of chance susceptible to representation in an electronic or electromechanical form, which in some embodiments produces a random outcome based on probability data at the time of or after placement of a wager. That is, different primary wagering games, such as video poker games, video blackjack games, video keno, video bingo or any other suitable primary game may be implemented.

In some embodiments, the chance-based prize round may be a slot game with one or more paylines that may be horizontal, vertical, circular, diagonal, angled or any combination thereof. In some embodiments, the player may be awarded a number of paylines based on how they did in the skill-based challenge. In another embodiment, a subset of symbols are activated based on how the player did in the skill-based challenge. In another embodiment, a subset of paytable awards are activated based on how the player did in the skill-based challenge. In another embodiment, a subset of the reels are activated based on how the player did in the skill-based challenge. In another embodiment, the game uses one or more these methods in the slot game. In this embodiment, the EGM 100 includes at least one and preferably a plurality of reels, such as three to five reels, in either electromechanical form with mechanical rotating reels or video form with simulated reels and movement thereof. In some embodiments, an electromechanical slot machine includes a plurality of adjacent, rotatable reels which may be combined and operably coupled with an electronic display of any suitable type. In another embodiment, if the reels are in video form, one or more of the display devices, as described above, display the plurality of simulated video reels. Each reel may display a plurality of indicia or symbols, such as bells, hearts, fruits, numbers, letters, bars or other images which preferably correspond to a theme associated with the EGM 100. In another embodiment, one or more of the reels are independent reels or unisymbol reels. In this embodiment, each independent or unisymbol reel generates and displays one symbol to the player. In some embodiments, the EGM 100 awards prizes after the reels of the primary game stop spinning if specified types and/or configurations of indicia or symbols occur on an active payline or otherwise occur in a winning pattern, occur on the requisite number of adjacent reels and/or occur in a scatter pay arrangement.

In some embodiments, the chance-based prize round may be a poker game wherein the EGM 100 enables the player to play a conventional game of video draw poker and initially deals five cards all face up from a virtual deck of fifty-two card deck. In other embodiments, the composition of the deck may be dependent on how the player did in the skill-based challenge. For example, if the player scored well enough, the deck may also contain a Joker card. If the player scored extremely well, the deck may contain two Joker cards or one of the ranks or suits may be designated as wild. In another embodiment, the deck composition is created in favor of the player, based on the rules of the poker/card game round. The favorability of the deck's composition may be related to the player's performance in the skill-based challenge. Cards may be dealt as in a traditional game of cards or in the case of the EGM 100, may also include that the cards are randomly selected from a predetermined number of cards. If the player wishes to draw, the player selects the cards to hold via one or more input device, such as pressing related hold buttons or via the touch screen. The player then presses the deal button and the unwanted or discarded cards are removed from the display and the EGM deals the replacement cards from the remaining cards in the deck. This results in a final five-card hand. The EGM 100 compares the final five-card hand to a payout table which utilizes conventional poker hand rankings to determine the winning hands. The EGM 100 provides the player with an award based on a winning hand and the credits the player wagered.

In another embodiment, the chance-based prize round may be a multi-hand version of video poker. In this embodiment, the EGM 100 deals the player at least two hands of cards. In one such embodiment, the cards are the same cards. In some embodiments each hand of cards is associated with its own deck of cards. The player chooses the cards to hold in a primary hand. The held cards in the primary hand are also held in the other hands of cards. The remaining non-held cards are removed from each hand displayed and for each hand replacement cards are randomly dealt into that hand. Since the replacement cards are randomly dealt independently for each hand, the replacement cards for each hand will usually be different. The poker hand rankings are then determined hand by hand and awards are provided to the player.

In some embodiments, the chance-based prize round may be a keno game wherein the EGM 100 displays a plurality of selectable indicia or numbers on at least one of the display devices. In other embodiments, the number of balls drawn in the keno game may be dependent on how the player did in the skill-based challenge. For example, if the player did well enough in the skill-based challenge, the keno game may draw 25 balls instead of the usual 20 balls. If the player did extremely well in the skill-based challenge, the keno game may draw 30 balls instead of the usual 20 balls. In this embodiment, the player selects at least one or a plurality of the selectable indicia or numbers via an input device such as the touch screen. The EGM 100 then displays a series of drawn numbers to determine an amount of matches, if any, between the player's selected numbers and the EGM 100's drawn numbers. The player is provided an award based on the amount of matches, if any, based on the amount of determined matches and the number of numbers drawn.

Player Tracking

In various embodiments, the gaming system includes one or more player tracking systems under control of the player tracking module 20B shown in FIG. 1C. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a cell phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device. At least U.S. Pat. Nos. 6,722,985; 6,908,387; 7,311,605; 7,611,411; 7,617,151; and 8,057,298 describe various examples of player tracking systems.

As noted above, a player's progress or status can be saved in other ways besides using a player tracking system, such as by generating, when the player cashes out, a ticket including a printed code, such as a bar code or QR code, that identifies the player's session. When the player wants to continue the game, the player may insert the ticket including the printed code into the bill/ticket acceptor 128 of an EGM 100 (which may or may not be the same EGM 100 from which the ticket was issued). The EGM 100 reads the printed code and retrieves the player's status in response to the printed code.

Other EGM Features

Embodiments described herein may be implemented in various configurations for EGMs 100s, including but not limited to: (1) a dedicated EGM, wherein the computerized instructions for controlling any games (which are provided by the EGM) are provided with the EGM prior to delivery to a gaming establishment; and (2) a changeable EGM, where the computerized instructions for controlling any games (which are provided by the EGM) are downloadable to the EGM through a data network when the EGM is in a gaming establishment. In some embodiments, the computerized instructions for controlling any games are executed by at least one central server, central controller or remote host. In such a “thin client” embodiment, the central server remotely controls any games (or other suitable interfaces) and the EGM is utilized to display such games (or suitable interfaces) and receive one or more inputs or commands from a player. In another embodiment, the computerized instructions for controlling any games are communicated from the central server, central controller or remote host to a EGM local processor and memory devices. In such a “thick client” embodiment, the EGM local processor executes the communicated computerized instructions to control any games (or other suitable interfaces) provided to a player.

In some embodiments, an EGM may be operated by a mobile device, such as a mobile telephone, tablet other mobile computing device.

In some embodiments, one or more EGMs in a gaming system may be thin client EGMs and one or more EGMs in the gaming system may be thick client EGMs. In another embodiment, certain functions of the EGM are implemented in a thin client environment and certain other functions of the EGM are implemented in a thick client environment. In one such embodiment, computerized instructions for controlling any primary games are communicated from the central server to the EGM in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more EGMs; and/or (c) one or more personal EGMs, such as desktop computers, laptop computers, tablet computers or computing devices, personal digital assistants (PDAs), mobile telephones such as smart phones, and other mobile computing devices.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In some embodiments in which the gaming system includes: (a) an EGM configured to communicate with a central server, central controller, or remote host through a data network; and/or (b) a plurality of EGMs configured to communicate with one another through a data network, the data network is an internet or an intranet. In certain such embodiments, an internet browser of the EGM is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central controller, or remote host and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

Examples of implementations of Internet-based gaming are further described in U.S. Pat. No. 8,764,566, entitled “Internet Remote Game Server,” and U.S. Pat. No. 8,147,334, entitled “Universal Game Server,” which are incorporated herein by reference.

### Further Definitions and Embodiments

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a non-transitory computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed typical embodiments and, although specific terms are employed, they are used in a generic and descriptive sense only and not for purposes of limitation, the scope of the inventive concepts being set forth in the following claims.

What is claimed is:

1. A gaming system comprising:
a processor;
a display device;
an input device; and
a memory device storing a plurality of instructions which, when executed by the processor, cause the processor to operate with the display device and the input device, for a play of a hybrid skill and chance based wagering game, to:
receive a wager from a player;
determine that the player has purchased at least one persistent skill enhancement to a skill-based challenge that can be used by the player whenever the player is playing the skill-based challenge; and
initiate, in response to the wager, the skill-based challenge including the at least one persistent skill enhancement, where an outcome of the skill-based challenge is affected by the persistent skill enhancement;
in response to an outcome of the skill-based challenge, award the player at least one entry into a chance-based prize round, wherein a probability of winning the chance-based prize round may be enhanced based on the outcome of the skill-based challenge;
initiate the chance-based prize round; and
award a monetary prize to the player in response to an outcome of the chance-based prize round.

2. The gaming system of claim 1, wherein the persistent skill enhancement is usable by the player in the skill-based challenge and in subsequent plays of the skill-based challenge.

3. The gaming system of claim 2, wherein the persistent skill enhancement is usable by the player in subsequent plays of the skill-based challenge on different gaming systems.

4. The gaming system of claim 3, wherein the different gaming systems are located on different premises.

5. The gaming system of claim 2, wherein the persistent skill enhancement is usable by the player in subsequent plays of the skill-based challenge on different gaming systems operated by different casino operators.

6. The gaming system of claim 1, wherein the instructions further cause the processor to award the player an entry into a progressive lottery game in response to the outcome of the skill-based challenge.

7. The gaming system of claim 6, wherein the progressive lottery game comprises a wide area progressive lottery game.

8. The gaming system of claim 1, wherein awarding the player the at least one entry into the chance-based prize round comprises awarding the player a plurality of entries into the chance-based prize round in response to the player's performance in the skill-based challenge.

9. The gaming system of claim 8, wherein the instructions further cause the processor, in the chance-type game to:
display a plurality of symbols on the display device, wherein at least one of the plurality of symbols corresponds to a hidden prize symbol that has an associated hidden prize;
receive at least one selection from the player of at least one symbol of the plurality of symbols that are displayed on the display device;
reveal to the player whether the hidden prize symbol is associated with the selected at least one symbol; and
if the hidden prize symbol is associated with the selected at least one symbol, award the hidden prize to the player.

10. The gaming system of claim 9, wherein the instructions further cause the processor to receive a number of additional selections of symbols equal to a number of entries awarded in the chance-based prize round to the player in response to the outcome of the skill-based challenge.

11. The gaming system of claim 1, wherein the instructions further cause the processor to:
receive notification from a wide area progressive server that a jackpot is ready to be awarded in a wide area progressive game;
initiate play of a wide area skill-based challenge against players of other gaming systems that are participating in the wide area progressive game; and
notify the player that the player has won or not won the jackpot in response to an outcome of the wide area skill-based challenge.

12. The gaming system of claim 11, wherein the persistent skill enhancement is usable in the wide area skill-based challenge.

13. The gaming system of claim 1, wherein the instructions further cause the processor to:
evaluate a skill level of the player during play of the skill-based challenge; and
select a paytable from among a plurality of potential paytables in response to the evaluated skill level of the player;
wherein the monetary prize is awarded based on the selected paytable.

14. The gaming system of claim 1, wherein the skill-based challenge comprises an object pairing game, and wherein the instructions further cause the processor to:
control the display to display computer game graphics of a gameboard including multiple game elements arranged in a matrix;
receive a selection from the user using the input device of a subset of the multiple game elements; and
award points to the player when the subset of the multiple game elements comprises at least two game elements that are adjacent to one another on the gameboard.

15. The gaming system of claim 1, wherein the instructions further cause the processor to present a set of avatars for selection by the player, wherein the persistent skill enhancement comprises an upgraded avatar in the set of avatars, wherein the upgraded avatar provides a skill enhancement to the player while playing the skill-based challenge.

16. The gaming system of claim 13, wherein the instructions further cause the processor to:
determine a number of credits wagered by the player; and
allocate a portion of the credits wagered by the player towards a secondary prize that is awarded for an event other than an outcome of the chance-based prize round;
wherein the portion of the credits allocated towards the secondary award is determined in response to the evaluated skill level of the player.

17. The gaming system of claim 16, wherein the secondary prize is allocated to be awarded in response to an event in the skill-based challenge.

18. The gaming system of claim 16, wherein the secondary prize is allocated to be awarded in response to an instant win event in the skill-based challenge.

19. The gaming system of claim 16, wherein the secondary prize is allocated to be awarded in response to a progressive jackpot drawing.

20. The gaming system of claim 1, wherein the instructions further cause the processor to present a plurality of play levels to the player, wherein each play level has an associated gameboard including a plurality of game elements, and wherein each play level is associated with one of a plurality of game areas such that the player completes the play levels, the player advances through successive ones of the game areas;
wherein at least one of the plurality of game areas is associated with a progressive jackpot game; and
wherein the player must complete the at least one of the plurality of game areas to be qualified for the progressive jackpot game.

21. The gaming system of claim 20, wherein the progressive jackpot comprises a must-hit-by progressive jackpot game.
